(19) United States
(12) Patent Application Publication
(10) Pub. No.: US 2005/0240381 A1
(43) Pub. Date: Oct. 27, 2005

(54) Systems and methods for analysis of a commodity transmission network

(75) Inventors: Kenneth S. Seiler, Phoenixville, PA (US); Michael R. Colby, Pottstown, PA (US); Jacob M. Terkanian, Chalfont, PA (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: PJM Interconnection, LLC.

(21) Appl. No.: 10/832,975

(22) Filed: Apr. 26, 2004

(51) Int. Cl. G06F 17/50

(52) U.S. Cl. 703/1

(57) ABSTRACT

Systems and methods for identifying an operating characteristic in a commodity transport network model may involve displaying a scaled map of a region; receiving flow information corresponding to a user-selected object displayed on the map; and, using the flow information, identifying the operating characteristic. Systems and methods for representing an event in a display of a planning project analysis computer system may involve representing on the display a scaled map of a region; and displaying on the display an indication of the event. The indication may designate a position in the display that corresponds a location of the event.

### BACKGROUND OF THE INVENTION

Establishing or maintaining the reliability of commodity transport networks often requires the identification of an operating characteristic that may occur in a member of the network as a commodity flows through the member. Commodity transport networks may include, without limitation, electric power transmission grids, water distribution systems, gas distribution systems, oil distribution systems, telecommunication networks and cable-based information distribution networks. Flow through networks that include a large number of members are often analyzed using a numerical model that represents the network. Planning a new network or planning modifications of an existing network often involve visualizing spatial relationships between network members, identifying conflicts between one planned modification and another planned modification, and identifying the affect of temporal information, such as a construction schedule, on the implementation of a planned modification.

Known systems and methods for identifying an operating characteristic in connection with planning a new network or planning modifications of an existing network do not provide a user with adequate means of visualizing spatial relationships between network members and do not provide a user-friendly means of incorporating information representing a possible change into a numerical model of the network. Known systems and methods for network planning do not show temporally-referenced information on geographically scaled maps.

It would therefore be desirable to provide systems and methods for analyzing a commodity transport network that provide a user with a geographically scaled map upon which to graphically set forth network modeling information, that incorporate the displayed information into a network model, and that identify an operating characteristic of the model.

It would therefore also be desirable to provide systems and methods for identifying temporally-referenced information on the geographically scaled map.

### SUMMARY OF THE INVENTION

It is an object of this invention to provide systems and methods for analyzing a commodity transport network that provide a user with a geographically scaled map upon which to graphically set forth network modeling information, that incorporate the information into a network model, and that identify an operating characteristic of the model.

It is another object of the invention to provide systems and methods for identifying temporally-referenced information on the geographically scaled map.

In accordance with the principles of the invention, there are provided systems and methods for electronically identifying an operating characteristic in a model of a commodity transport network. The model may be configured to simulate a flow of the commodity through the network. The systems and methods may provide for displaying a scaled map of a region; receiving flow information corresponding to a user-selected object displayed on the map; and, using the flow information, identifying the operating characteristic.

In accordance with the principles of the invention, there also are provided systems and methods for representing an event in a display of a project analysis computer system. The event may correspond to a time. The systems and methods may provide for representing on the display a scaled map of a region and displaying on the display an indication of the event. The indication may designate a position in the display and the position may correspond to a location of the event.

### BRIEF DESCRIPTION OF THE DRAWINGS

Further features of the invention, its nature and various advantages will be more apparent from the following detailed description of the invention taken in conjunction with the accompanying drawings, in which:

FIG. 1 is a schematic diagram of illustrative apparatus that may be used in accordance with the principles of the invention;

FIG. 2 is a schematic diagram of other illustrative apparatus that may be used in accordance with the principles of the invention;

FIG. 3 is a schematic diagram of still other illustrative apparatus that may be used in accordance with the principles of the invention;

FIG. 4 is a block diagram of an illustrative system in accordance with the principles of the invention and possible inputs to the system;

FIG. 5 is a flow diagram showing illustrative steps that may be included in a method in accordance with the principles of the invention;

FIG. 6 is a schematic diagram of illustrative elements of a commodity transport network model that may be analyzed in accordance with the principles of the invention;

FIG. 7 is an illustrative example of a data table showing illustrative data that may be used in accordance with the principles of the invention;

FIG. 8 is an another illustrative example of a data table showing illustrative data that may be used in accordance with the principles of the invention;

FIG. 9 is yet another illustrative example of a data table showing illustrative data that may be used in accordance with the principles of the invention;

FIG. 10 is still another illustrative example of a data table showing illustrative data that may be used in accordance with the principles of the invention;

FIG. 11 is still another illustrative example of a data table showing illustrative data that may be used in accordance with the principles of the invention;

FIG. 11A is still another illustrative example of a data table showing illustrative data that may be used in accordance with the principles of the invention;

FIG. 12 is a schematic diagram showing illustrative relationships between illustrative types of information that may be present in a commodity transport network model that may be analyzed in accordance with the principles of the invention;

FIG. 13 is a schematic diagram showing an illustrative sample commodity transport network model and portions of a system for analyzing the sample in accordance with the principles of the invention;

FIG. 14 is still another illustrative example of a data table showing illustrative data that may be used in accordance with the principles of the invention;

FIG. 15 is still another illustrative example of a data table showing illustrative data that may be used in accordance with the principles of the invention;

FIG. 16 is a flow diagram showing illustrative steps that may be included in another method in accordance with the principles of the invention;

FIG. 17 is an illustrative display that may be provided in accordance with the principles of the invention;

FIG. 18 is another illustrative display that may be provided in accordance with the principles of the invention;

FIG. 19 is yet another illustrative display that may be provided in accordance with the principles of the invention;

FIG. 20 is still another illustrative display that may be provided in accordance with the principles of the invention;

FIG. 21 is still another illustrative display that may be provided in accordance with the principles of the invention;

FIG. 22 is still another illustrative display that may be provided in accordance with the principles of the invention;

FIG. 23 is a flow diagram showing illustrative steps that may be involved in developing a commodity flow network and may be involved in analysis of the network in accordance with the principles of the invention;

FIG. 24 is another flow diagram showing illustrative steps that may be involved in developing a commodity flow network and may be involved in analysis of the network in accordance with the principles of the invention;

FIG. 25 is yet another flow diagram showing illustrative steps that may be involved in developing a commodity flow network and may be involved in analysis of the network in accordance with the principles of the invention;

FIG. 26 is still another flow diagram showing illustrative steps that may be involved in developing a commodity flow network and may be involved in analysis of the network in accordance with the principles of the invention;

FIG. 27 is still another flow diagram showing illustrative steps that may be involved in developing a commodity flow network and may be involved in analysis of the network in accordance with the principles of the invention;

FIG. 28 is still another illustrative example of a data table showing illustrative data that may be used in accordance with the principles of the invention;

FIG. 29 is still another illustrative example of a data table showing illustrative data that may be used in accordance with the principles of the invention;

FIG. 30 is a flow diagram showing illustrative steps that may be included in yet another method in accordance with the principles of the invention;

FIG. 31 is still another illustrative display that may be provided in accordance with the principles of the invention; and

FIG. 32 is still another illustrative display that may be provided in accordance with the principles of the invention; and

FIG. 33 is still another illustrative display that may be provided in accordance with the principles of the invention.

### DETAILED DESCRIPTION OF THE INVENTION

In some embodiments, the invention may provide systems and methods for electronically identifying a simulated operating characteristic in a model of a commodity transport network. The model may be configured to simulate a flow of the commodity through the network. In some embodiments, the invention may include a method that includes displaying a scaled map of a region; receiving flow information corresponding to a user-selected object displayed on the map; and, using the flow information, identifying the operating characteristic.

In some embodiments, the invention may include a system for electronically identifying the simulated operating characteristic. The system may include an electronic display device configured to display the scaled map; a user input device configured to receive the flow information; and a processor configured to use the flow information to identify the operating characteristic. (As used herein, the term “processor” may refer to one or more physical devices that may be present at one or more physical locations.) Systems may be provided for performing steps of any of the methods or processes shown or described herein.

A network will be understood to be made up of one or more infrastructure units. Infrastructure units may be interconnected such that the commodity may flow from one to another. Some infrastructure units may generate the commodity. Some infrastructure units may consume the commodity. Some infrastructure units may transport the commodity. Some infrastructure units may transform the commodity. For example without limitation, an infrastructure unit may change a potential, such as a voltage or a pressure, of the commodity. An infrastructure unit may change a phase of the commodity. A network may include one or more of a bulk-power grid, a bulk-power system, a power grid, a merchant transmission network and a multiple merchant transmission network.

The model will be understood to be made up of one or more “elements.” An element may correspond to an infrastructure unit. An element may function, as part of the model, as a simulated infrastructure unit. The model may include data that correspond to each element. The data may be stored in a model database. As used herein, a “facility” may include one or more infrastructure units. A facility may include apparatus and systems that may be used in connection with an infrastructure unit or units.

The method may include transferring at least a portion of said flow information from a storage device operatively associated with the display to a storage device configured to store data corresponding to an element of the model. The transferring may be performed before the identifying. The identifying may include communicating at least a portion of the flow information and at least a portion of said data to a commodity transport network analysis computer program. At least a portion of said flow information placed on said map via a user input device.

In some embodiments of the invention, the receiving may precede the identifying. The method may include receiving, before the receiving flow information, a user instruction to display the object on the map.

The object may represent an element of the model. The method may include displaying the object; and, after displaying the object, transferring at least a portion of the flow information to a storage device configured to store a parameter corresponding to the model element. As used herein, a parameter may include any suitable engineering, geographical, topological, temporal, financial, legal, planning-related or database-related information corresponding to a commodity transport network.

The user-selected object may be a representation of a model element. The user-selected object may include an attribute. The attribute may correspond to a model element parameter associated with the model element that the user-selected object represents. The user-selected object may include an attribute corresponding to some or all parameters of the corresponding model element. The attribute may be stored in any suitable database. The attribute may be stored in any suitable data structure and may be displayed or arranged in a table. The attribute may be associated in a database with an object identifier. The object identifier may be used to extract the attribute from the database upon selection of the object (for example, via a mouse-click) by a user. The user may be any user of any of the systems, devices or methods described herein.

In some embodiments, the flow information may include information regarding a simulated perturbation of the flow. The perturbation may include an addition of a model element. The perturbation may include a deletion of a model element. The perturbation may include a modification of a model element. The perturbation may include setting a model element to “inactive” status. The perturbation may include setting a model element to “active” status. Active and inactive statuses may be stored in a model database.

In some embodiments of the invention, a new model element may be established by assigning an identifier to the model element and then assigning a value to a parameter of the new model element. The value may be the same as the value of an attribute of the user-selected object. A new model element may, therefore, be established based on the user-selected object. An existing model element may, therefore, be modified based on an attribute value of the user-selected object.

In some embodiments, the flow information may include an instruction to remove the object from the map and; the receiving may precedes the identifying. The method may include removing the object from the map; and, after removing the object, transferring at least a portion of the flow information to a storage device configured to store a parameter corresponding to the model element.

In some embodiments, the flow information may include an instruction to replace a first parameter value corresponding to an element in the model with a second parameter value.

The identifying may include computing a value of the operating characteristic; and displaying on the map a representation of the value.

The flow information may include an attribute value for the user-selected object. The attribute value may be any suitable attribute value, including without limitation any model element parameter described herein.

The flow information may include a simulated flow rate. The flow rate may be a rate of addition of the commodity at the location. The flow rate may be a rate of consumption of the commodity at the location. The rate of consumption may correspond to the presence of a load. The flow rate may be a rate of removal of the commodity from the network. The rate of removal may correspond to a transfer of the commodity from the network. The rate of removal may correspond to a transfer of the commodity to a second network.

The flow information may include a simulated modification of the commodity at the location. The modification may be a quantifiable modification. For example, the modification may be a power factor correction. A power factor correction may be effected by addition of a simulated capacitor. A power factor correction may be effected by deletion of a simulated capacitor. A power factor correction may be effected by the modification of a simulated capacitor.

The modification may be an addition of a substance to the commodity. The modification may be a deletion of a substance to the commodity. For example, when the commodity is water, the modification may include one or more of adding chlorine to the water, removing a gas from the water, and removing suspended matter from the water.

The flow information may include a simulated flow source type. The flow source type may be an electric power generator. The flow source type may be a merchant transmission infrastructure unit. Examples of merchant transmission infrastructure units include without limitation a merchant transmission source, which may be a generator or any other infrastructure unit. As used herein, a merchant transmission source is a source that is external to the network and provides commodity flow to the network.

The flow information may include simulated outage information. The outage information may correspond to a transmission outage. The outage information may correspond to an equipment outage. The outage information may correspond to a generation plant outage. The outage information may correspond to an out-of-service date.

The method may include receiving a first parameter corresponding to a first element that corresponds to at least one position on the map. The method may include receiving an instruction to connect the first element to a portion of the model. The method may include displaying a representation of the first element on the map at the position.

The method may include receiving a second parameter corresponding to a second element that corresponds to at least one position on the map and receiving an instruction to connect the first element to the second element.

The method may include displaying on the map a representation of an element corresponding to the location. The displaying may include receiving from a user an instruction to display the representation on the map.

The flow information may include a model element type. The type may be a generator. The type may be a transmission line. The type may be a merchant-transmission transmission line. The type may be a transformer. The type may be a circuit breaker. The type may be a bus. The type may be a switch. The type may be a load. The type may be a capacitor. The type may be a phase angle regulator. The type may be a wave trap. The type may be switch gear.

The method may include displaying on the map a monetary value corresponding to an infrastructure unit. The value may be a construction cost value. The method may include displaying on the map at least a portion of a document corresponding to an infrastructure unit. The document may include a photograph. The document may include a contract. The document may include an engineering diagram. The document may include project schedule information.

The method may include associating with a queue a request to connect an infrastructure unit to the network. As used herein, a “queue” is a sequence of items, each including one or more infrastructure units proposed or requested to be added to the network. A queue may be assigned an identifier. Each queue identifier may correspond to one or more infrastructure units, all of which are common to the request. After a queued infrastructure unit is connected to the network (i.e., after the request is fulfilled) the unit may retain its association with the queue identifier.

The method may include associating with a queue an element of the model. In some embodiments, the method may include receiving queue identification information identifying a queue and displaying on the map a representation of an element corresponding to an infrastructure unit only if the infrastructure unit is part of the queue.

The method may include identifying a first time at which to simulate the flow; identifying a second time corresponding to an element of the model; and, if the second time is no earlier than the first time, displaying the model element. The identifying may include calculating a value of the operating characteristic. The identifying may include identifying a first time at which to simulate the flow; identifying a second time corresponding to an element of the model; and, if the second time is no earlier than the first time, calculating a value of the operating characteristic.

Each of the times may include a date. The second time may include an in-service date. (As used herein, an in-service date is a date upon which an infrastructure unit is planned to provide service to the network or a date upon which an infrastructure unit began providing service to the network.) The second time may include a completion date. The completion may be a completion of the perturbation. The completion may be the completion of a construction. The completion may be a completion of a restoration of an infrastructure unit. The second time may include a contractual date. The second time may include a certification date. The second time may include a study date. The method may include storing the second time in a data storage device. The method may include retrieving the second time from a data storage device.

The identifying may include comparing a calculated value of the operating characteristic to an established value of the characteristic. The established value may be associated with an infrastructure unit. The operating characteristic may be any suitable flow characteristic. The operating characteristic may be a characteristic of the commodity. The operating characteristic may be any characteristic of apparatus that transports the commodity. The operating characteristic may be a characteristic of electrical current. The operating characteristic may be a characteristic of apparatus that transports the current.

The calculated value may include a voltage value. The calculated value may include a phase angle value. The calculated value may include a current value. The current value may be at least partially identified as a number of amperes. The calculated value may include a temperature value. The calculated value may include a power value. The power value may be at least partially identified as a number of watts. The power value may be at least partially identified as a number of volts-amperes, reactive (hereinafter, “VARS”).

The established value may correspond to a design characteristic. The established value may be a limit of an operating characteristic value for an infrastructure unit. The established value may be a threshold for an operating characteristic value for an infrastructure unit. If the infrastructure unit is operated with an operating characteristic value that exceeds the limit, or does not meet the threshold value, the reliability of the infrastructure unit may be diminished. The established value may include a voltage value. The established value may include a phase angle value. The established value may include a current value. The current value may be at least partially identified as a number of amperes. The established value may include a temperature value. The established value may include a power value. The power value may be at least partially identified as a number of watts. The power value may be at least partially identified as a number of VARS.

The comparing may include identifying a difference between the calculated value and the established value. The method may include displaying on the map a representation of the difference. The representation of the difference may be associated graphically with a representation of an element of said model. The representation of the difference may include an area of the map surrounding the representation of the element.

The commodity may include electric power. The network may include an electric power transmission grid. The flow may include electric current. The current may include alternating current. The current may include direct current.

Some embodiments of the invention may provide a method for representing an event in a display of a project planning analysis computer system. The system may be a system for designing a commodity transport network. The system may be a system for identifying an operating characteristic in a model of a commodity transport network. The event may correspond to a time. The method may include representing on the display a scaled map of a region and displaying on the display an indication of the event. The indication may designate a position in the display. The position may correspond to a location of the event.

The event may include an initiation of a construction. The event may include a completion of a construction. The event may include an initiation of a study. The event may include a completion of a study. The study may include a planning power analysis study. The event may include an execution of an agreement. The event may include an initiation of a test. The event may include a completion of a test. The event may include an initiation of an inspection. The event may include a completion of an inspection. The event may include an authorization of an expenditure. The expenditure may be an expenditure that is identified in an agreement. The agreement may be any suitable type of agreement. The agreement may be any suitable type of contract. The agreement may include an interconnection service agreement. The agreement may be an interconnection construction agreement. The expenditure may be an expenditure that is identified in a budget. The expenditure may correspond to a purchase of electrical equipment. The service may include maintenance. The service may include equipment modification. The expenditure may correspond to a service of electrical equipment. The event may include a receipt of funds. The funds may correspond to a purchase of electrical equipment. The funds may correspond to a service of electrical equipment.

The method may include comparing a first amount to a second amount. The first amount may correspond to a transfer of funds. The event may include the transfer. The second amount may be identified in a budget.

The event may be part of a commodity supply infrastructure modification.

Displaying an indication of the event on a display may include identifying a time-referenced tabular data record with a geographically-referenced data object corresponding to the position. The record may correspond to the event. The associating may include identifying the event in a lookup table. The table may include an identifier of the record and an identifier of the object.

The method may include displaying an item on the display. The item may correspond to the event. The item may include at least a portion of a photograph. The item may include project schedule information. The item may comprise a date. The date may be an in-service date. The date may be a date of completion of a project. The date may be any suitable date.

Some embodiments of the present invention may be implemented using any systems or methods suitable at least for supporting the interaction of a user with a display. Some embodiments of the present invention may be implemented using any systems or methods suitable for retrieving data from a storage device, identifying related data and displaying representations of data.

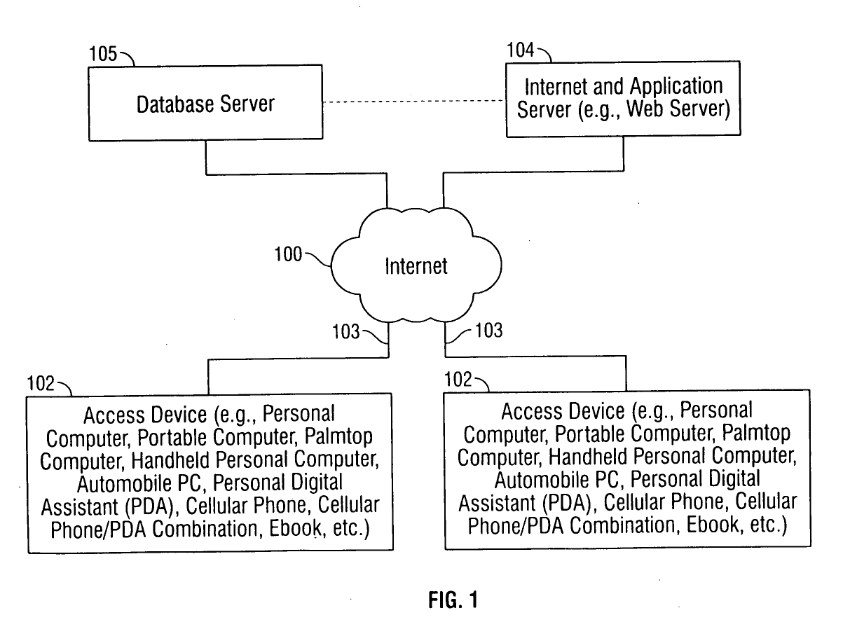

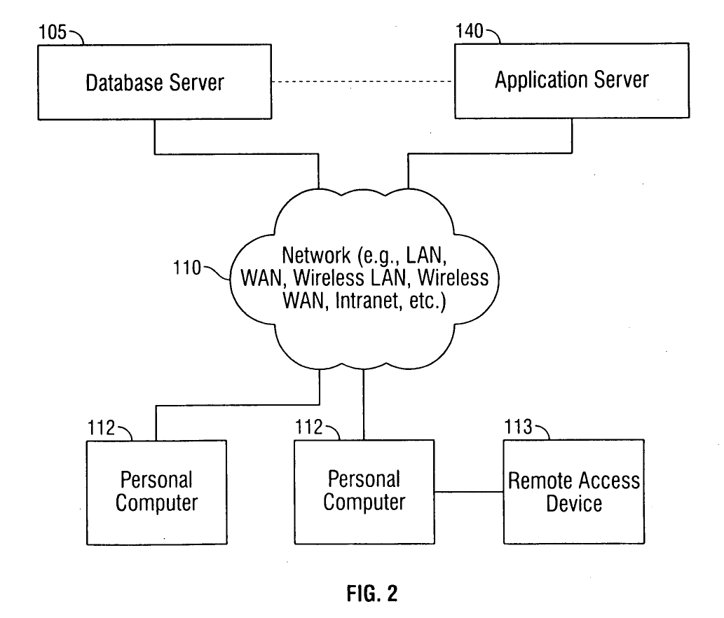

Some embodiments of the invention may be implemented, for example, using non-on-line client/server or peer-to-peer based approaches. In other embodiments, web-based or on-line approaches may be used. If desired, a combination of these approaches may be used. Illustrative on-line and non-on-line based arrangements for a network analysis system are shown in FIGS. 1 and 2, respectively.

In the illustrative on-line arrangement of FIG. 1 access devices 102 may be connected via links 103 to Internet 100. Access devices 102 may include any device or combination of devices suitable for providing Internet access to a user of the system. Access devices may include, for example, any suitable personal computer (PC), portable computer (e.g., a notebook computer), palmtop computer, handheld personal computer (H/PC), automobile PC, personal digital assistant (PDA), Internet-enabled cellular phone, combined cellular phone and PDA, ebook, or other device suitable for providing Internet access.

Internet and application server 104 may be any server suitable for providing on-line access to a commodity transport network analysis web site. Internet and application server 104 may, for example, provide one or more pages to access devices 102 using one or more suitable protocols (e.g., the HyperText Transfer Protocol (HTTP) and Transmission Control Protocol/Internet Protocol (TCP/IP)). The pages may be defined using, for example, any suitable markup language (e.g., HyperText Markup Language (HTML), Dynamic HyperText Markup Language (DHTML), pages defined using the Extensible Markup Language (XML), JavaServer Pages (JSP), Active Server Pages (ASP), or any other suitable approaches). The pages may include scripts, computer code, or subsets of computer code, that define mini-programs (e.g., Perl scripts, Java applets, Enterprise JavaBeans (EJB), or any other suitable approaches). The system may be designed using any suitable modular approach such as, for example, Java 2 Platform—Enterprise Edition (J2EE), Component Object Model (COM), Distributed Component Object Model (DCOM), or any other suitable approach.

Internet and application server 104 may run a database engine suitable for maintaining a database of commodity transport network information such as, for example, Microsoft SQL Server, Microsoft Project, Oracle, or any other suitable database engine. Internet and application server 104 may run Microsoft Internet Information Server. Server 104 may run any geographic information system or geographic information analysis platform. For example, server 104 may run a geographic information system such as that sold under the trademark ARCGIS by Environmental Systems Research Institute, Inc. of Redlands, Calif. Server 104 may run a schedule server applications such as that sold under the name MICROSOFT PROJECT by the Microsoft Corporation of Redmond, Wash. Server 104 may run a power system simulation application such as that sold under the trademark PSS/E by Shaw Power Technologies, Inc. of Schenectady, N.Y. Server 104 may run a power flow management application such as that sold under the trademark MUST by Shaw Power Technologies, Inc. Server 104 may run a spreadsheet application such as that sold under the trademark EXCEL by the Microsoft Corporation.

Server 104 may run a graphics application such as that sold under the trademark CRYSTAL REPORTS by Seagate Software, Inc., of Scotts Valley, Calif. The graphics application may be configured to provide graphs based on data stored in database server 105. In some embodiments of the invention, more than one database may be present in conjunction with database server 105. In some embodiments, more than one database server may be present in place of database server 105. In practice, features of Internet and application server 104 may be integrated into a single server, or may be distributed across multiple servers that are interconnected via Internet 100 or any other suitable network.

Links 103 may include any transmission medium suitable for providing Internet access to access devices 102. Links 103 may include, for example, a dial-up telephone line, a computer network or Internet link, an infrared link, a radio frequency link, a satellite link, a digital subscriber line link (e.g., a DSL link), a cable TV link, a DOCSIS link, or any other suitable transmission link or suitable combination of such links. Different links 103 may be of different types depending on, for example, the particular type of access devices 102.

Any protocol or protocol stack suitable for supporting communications between access devices 102 and Internet and application server 104 over links 103 based on the particular device 102 and link 103 may be used. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internet work Packet Exchange (SPX/FPX) protocols, or any other suitable protocol or combination of protocols may be used.

FIG. 2 shows another illustrative arrangement for the commodity transport network analysis system of the present invention. Network 110 may be any suitable wire-based, fiber-based, or wireless local area network (LAN), wide area network (WAN), intranet, or other suitable network. Personal computers, and their interconnection via networks, are well known. Personal computers 112 may run suitable e-mail, HTTP, or other clients and client applications for providing users with access to the features of the system. In a suitable approach, personal computers 112 may run suitable Internet browsers to provide users with access to the Internet via an Internet server (not shown). If desired, one or more personal computers 112 may be accessed by remote access device 113 to provide remote access to users to the system. Remote access device 130 may be any suitable device, such as a personal computer, personal digital assistant, cellular phone, or other device with remote access capabilities.

Database server 105 of FIGS. 1 and 2 may be any computer-based system suitable for maintaining a database commodity transport network information. In particular, database server 105 may store one or more of identifiers of infrastructure units, parameters of infrastructure units, identifiers of events, parameters of events, identifiers of network model elements, parameters of model elements and any other suitable information. Database server 105 may run a database engine suitable for maintaining a database of item information such as, for example, Microsoft SQL Server, Microsoft Project, Oracle, or any other suitable database engine. Database server 105 is shown as being connected to server 104 via Internet 100 and server 140 via network 110. Server 140 may run any suitable versions of any of the applications or systems mentioned above in connection with server 104. In practice, database server 105 may be connected to server 104 or server 140 using a direct communication link. The features of database server 105 may be provided using a single server, distributed across multiple servers, or integrated into server 104 or server 140.

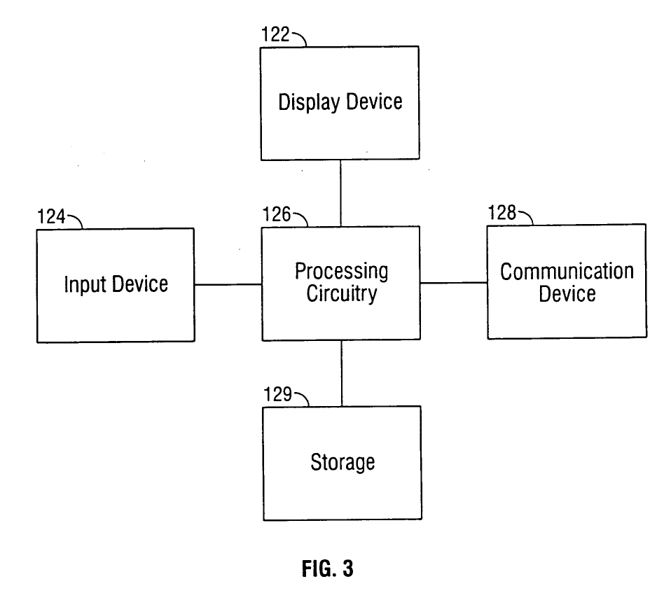

FIG. 3 shows an illustrative, generalized arrangement for one or more of access devices 102 (shown in FIG. 1), personal computers 112 and remote access device 113 (shown in FIG. 2). An access device 102 may include, for example, user input device 124, processing circuitry 126, communication device 128, storage device 129, and display device 122. User input device 124 may be any suitable input device. User input device 124 may include, for example, a pointing device, a keyboard, a touch-pad, a touch screen, a pen stylus, a voice recognition system, a mouse, a trackball, a joystick or any other suitable user input device. Processing circuitry 126 may include any suitable processor, such an Intel Pentium® microprocessor, and other suitable circuitry (e.g., input/output (I/O) circuitry, direct memory access (DMA) circuitry, etc.). Communication device 128 may be any device suitable for supporting communications over links 103. Communication device 128 may include, for example, a modem (e.g., any suitable analog or digital standard, cable, or cellular modem), a network interface card (e.g., an Ethernet card, token group card, etc.), a wireless transceiver (e.g., an infrared, radio, or any other suitable analog or digital transceiver), or any other suitable communication device. Storage 129 may be any suitable memory, storage device, or combination thereof, such as RAM, ROM, flash memory, a hard disk drive, etc. Display device 122 may include, for example, a cathode ray tube (CRT) monitor, liquid crystal display (LCD), voice synthesis processor and speaker, or any other suitable user output device. A user may interact with system 101 using one or more of access device 102, personal computer 112 and remote access device 113.

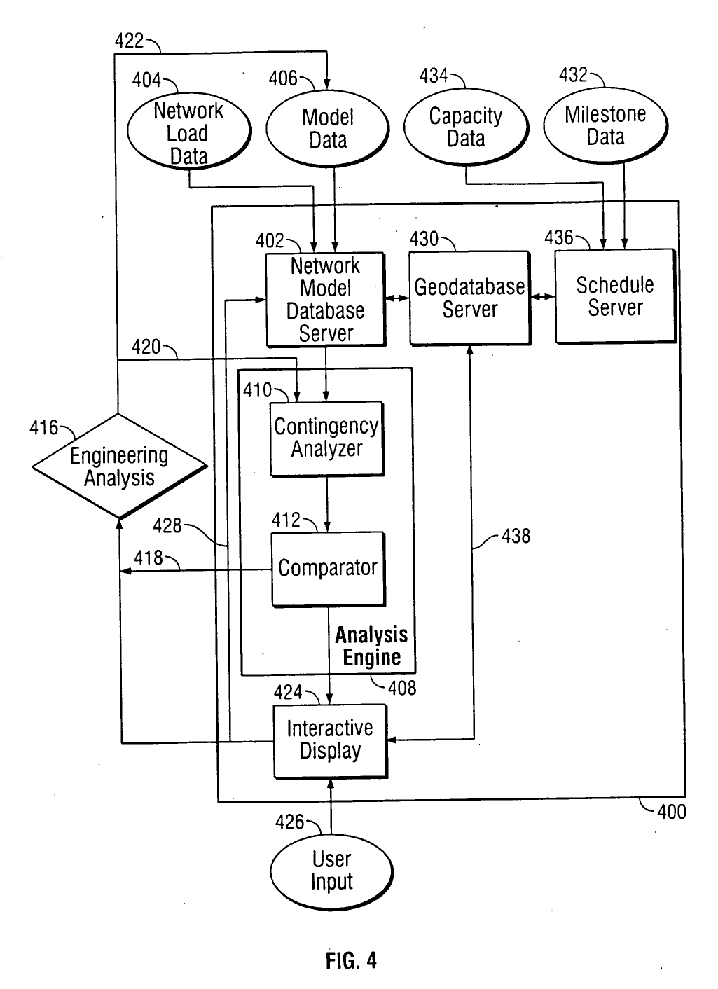

FIG. 4 shows an illustrative diagram of data flow through illustrative system 400. System 400 may be implemented using any suitable device or devices, including any of the devices shown in FIGS. 1-3. System 400 may be implemented using any suitable software, including without limitation applications discussed in connection with devices shown in FIGS. 1-3.

Model data 406 may include data that define a model of a commodity transport network. The model may be based on model elements. Each model element may correspond to an infrastructure unit. For the purpose of illustration, an electric power transmission grid will be used herein as an illustrative network, electric power will be used as an illustrative commodity and the network will be understood to be defined by one or more infrastructure units. Some of the infrastructure units may generate electric energy. Some may transport electric energy. Some may transform electric energy. Some may consume electric energy.

Data corresponding to each element may include an identifier that may identify the element. The data corresponding to each model element may include an identifier that identifies a corresponding infrastructure unit. The data may include one or more parameters, each of which may represent a property of the infrastructure unit, as described above.

Network model database server 402 may store model data 406. Database server 402 may provide model data 406 to another portion of system 400.

Load data 404 may include information corresponding to rates of consumption of electric power for different infrastructure units. Load data 404 may include historical values of electric power consumption. Load data 404 may include present values of electric power consumption. Load data 404 may include projected future values of electric power consumption. Database server 402 may store network load data 404. Database server 402 may provide network load data 404 to another portion of system 400.

Geodatabase server 430 may store geographic reference information associated with one or more of the model elements. Geographic reference information in geodatabase server 430 may be associated with a model element in network model database server 402 via a model element identifier. The model element identifier may be associated in a database on one or more of servers 402 and 430 with an infrastructure unit. The geographic reference information may correspond to a location of the infrastructure unit. The geographic reference information may correspond to a planned location of the infrastructure unit.

Schedule server 436 may store temporally-referenced information. Schedule server 436 may provide temporally-referenced information to another portion of system 400. For example without limitation, temporally-referenced information may include one or more of capacity data 434, milestone data 432 and any other suitable temporally referenced information. Temporally referenced information may include a date associated with an infrastructure unit. The date may be a date on which the infrastructure unit is scheduled to enter into service in the network. The date may be a date on which the infrastructure unit is scheduled to receive an equipment upgrade. The date may be a date on which the infrastructure unit is scheduled to be removed from service in the network. Temporally-referenced information may include a date that is associated with load data 404, which may include projected future values of electric power consumption.

A model element may be associated with one or more queues. A queue may include a list of requests. A request may be a request by a party to connect an infrastructure unit to the network. A model element, therefore, may be associated with a date or a queue because the element is associated with an infrastructure unit that is included in a queue.

Milestone data 432 may include one or more dates corresponding to events scheduled to occur in connection with the construction of an infrastructure unit that is scheduled to be connected to another infrastructure unit.

Capacity data 434 may include a prediction of the extent to which a planned infrastructure unit is likely to go into service in the network. The prediction may be based on historical data. The prediction may be based on an economic trend. The prediction may be based on a selected relationship between the trend and the likelihood that the planned infrastructure unit will go into service in the network. The prediction may be based at least partially on one or more construction schedules. The prediction may be based at least partially on one or more agreements.

In some embodiments of the invention, capacity data 434 may be used to identify an amount of power (e.g., in megawatts), that is provided to the network by in-service infrastructure units. In some embodiments of the invention, capacity data 434 may be used to identify an amount of power (e.g., in megawatts) that is planned to be provided to the network by infrastructure units that are planned to be in-service on a specified future date.

Schedule server 436 may provide milestone data 432 to geodatabase server 430. Schedule server 436 may provide capacity data 434 to database server 430. Schedule server 436 may provide any suitable temporal data to geodatabase server 430.

Load data 404 and model data 406 may be communicated from database server 402 to analysis engine 408. The data may be communicated in response to a user instruction. The user instruction may be input at interactive display 424 (as discussed below), which may have one or more of the features of one or more of access devices 102, personal computers 112 and remote access device 113 (shown in FIGS. 1-3).

One or more of database servers 402, 430, and 436 may be part of database server 105 (shown in FIGS. 1-2). Analysis engine 408 may include contingency analyzer 410 and comparator 412.

Contingency analyzer 410 may run an application configured to solve an equation that represents the flow of electric current through from one model element to another. The equation may be a linear equation. The equation may be a non-linear equation. The equation may be an equation that quantifies an amount of power generation required to balance a sum of loads and power losses. In some embodiments of the invention, the equation may be based on Kirchhoff's current law. In some embodiments of the invention, the equation may be based on Kirchhoff's voltage law. The equation may be any suitable equation based on electrical engineering principles. In some embodiments of the invention, a combination of current and voltage equations may be used.

Input to contingency analyzer 410 may include for each model element one or more of a model element identifier, a model element parameter (e.g., impedance), the identity of any other model element to which the model element is in simulated connection, a value of a simulated electrical power that energizes the model element, and a value of a load that consumes the power. Contingency analyzer 410 may receive data in any suitable format, including without limitation text tables in flat files. Contingency analyzer 410 may use the input data to populate one or more matrices to facilitate analysis of the data by contingency analyzer 410.

Contingency analyzer 410 may simulate a condition in a portion of the network and identify the value of a simulated operating characteristic, such as voltage, resulting from the simulated condition, in a model element of interest. The operating characteristic value may change in response to the condition because contingency analyzer 410 simulates the redistribution of current among infrastructure units in response to the condition. It will be understood that contingency analyzer 410 may simultaneously solve numerous electrical engineering equations and may identify values of operating characteristics for numerous model elements for each simulated condition. It will be understood further that contingency analyzer 410 may systematically simulate conditions in numerous model elements. The conditions may be different types of conditions. One example of a condition is an infrastructure unit failure.

Contingency analyzer 410 may be a contingency analyzer such as PSS/E, mentioned above.

Other examples, without limitation, of some of the conditions that contingency analyzer 410 may simulate are: an infrastructure unit retirement; an infrastructure unit addition; an infrastructure unit outage; a change in an infrastructure unit commodity flow rate; a change in an infrastructure unit commodity production rate; and a change in an infrastructure unit commodity consumption rate.

Contingency analyzer 410 may numerically simulate the flow of electric energy through the network using model data 406 to represent electric energy sources and transmission equipment and using load data 404 to represent electric energy consumption. Contingency analyzer 410 may calculate an extreme value of a simulated operating characteristic for one or more model elements under a simulated condition. The extreme value may be that value of an operating characteristic which is greatest for the respective element in view of one or more simulated network conditions.

Contingency analyzer 410 may communicate to comparator 412 a simulated operating characteristic extreme value for a model element. Comparator 412 may compare each extreme value to an established value for a corresponding infrastructure unit. For example, comparator 412 may compare an extreme value of power (e.g., in units of megavolt-amperes (“MVA”)), simulated to flow through a transmission line model element under a simulated network condition, to an established line rating for the corresponding transmission line. Comparator 412 may include any suitable calculation hardware or software suitable for performing arithmetic operations. For example, comparator 412 may include a spread sheet application such as that sold under the trademark EXCEL by Microsoft, Inc., of Redmond, Wash. In some embodiments of the invention, comparator 412 may include an analysis program such as the aforementioned MUST application.

Engineering analysis 416 may be performed, via path 418, on output from comparator 412. Analysis 416 may be performed by a user of system 400. Analysis 416 may provide the user with an opportunity to analyze the output and, along path 420, select a network condition simulated by contingency analyzer 410. Along path 422, a user may change model data 406 in response to output from comparator 412. A changed model may thus be stored in network model database server 402 and provided to contingency analyzer 410.

Comparator output and model data 406 may be communicated from comparator 412 to interactive display 424. In some embodiments of the invention, comparator 412 may provide interactive display 424 with a model element parameter. The model element parameter may be used to populate a display object attribute. In some embodiments of the invention, a display object may include one or more attributes corresponding to operating characteristics that may be identified by analyzer 410 during a simulation involving the model element.

For example without limitation, the display object may include an attribute that may be set to a value such as “Power Limit Exceeded”. The display object may include a corresponding attribute that identifies a graphic display feature that may be used to show that an operating characteristic limit (a power limit, in this example) was exceeded in a simulation performed by analyzer 410. For example, the graphic display feature may be a highlighting feature, a line-thickness feature or any suitable display feature that shows a user that a simulated operating characteristic exceeding a limit was identified in connection with the display object. Comparator 412 may provide interactive display 424 with any suitable information that may be used to set a display object value based on output from comparator 412.

Interactive display 424 may include any suitable apparatus and any suitable application for processing geographically-referenced information. Interactive display 424 may include any suitable apparatus and any suitable application for displaying geographically-referenced information. Interactive display 424 may include any suitable apparatus and any suitable application for receiving a user instruction to display a representation of a model element on a geographically-scaled map. Interactive display 424 may include any suitable apparatus and any suitable application for receiving a user instruction to remove a representation of a model element from a geographically-scaled map. Interactive display 424 may include any suitable apparatus and any suitable application for receiving a user instruction to edit a representation of a model element on a geographically-scaled map.

In some embodiments of the invention, interactive display 424 may store a model element identifier and a model element parameter in a storage device such as 129, may display a geographically scaled map on a display such as 122, may display a representation of the model element on display 122. Interactive display 424 may position the model element representation based on geographic information corresponding to the element. The geographic information may be stored in a database such as that in geodatabase server 430. Interactive display may receive user instructions via input device 124, may edit a representation of a model element on display 122 using processing circuitry 126, and may communicate information to and from another portion of system 400 via any suitable communication protocol. Interactive display 424 may receive a representation of an operating characteristic value from comparator 412. Interactive display 424 may display the representation on display 122. In some embodiments of the invention, interactive display 424 may communicate via a communication device such as device 128.

For example without limitation, interactive display 424 may run any suitable geographic information system, such as the aforementioned ARCGIS. Interactive display may run any suitable ARCGIS display tool, any suitable ARCGIS data object editing tool, any suitable ARCGIS database query tool, or any other suitable geographic information analysis tool.

For example, interactive display 424 may display the value of a simulated operating characteristic such as transmission line electric current output from comparator 412. The current value may be represented numerically. The current value may be represented graphically. For example, the transmission line may be represented using a color that corresponds to a current level. The transmission line may be represented using a color that corresponds to a current range that includes the value of the transmission line current output by contingency analyzer 410. The transmission line may be shown in a size that corresponds to a current value. The transmission line may be shown in a size that corresponds to a current range that includes the value of the transmission line current calculated by contingency analyzer 410. Any suitable symbol or symbols may be used to communicate that the transmission line is associated with an operating characteristic value or range of values.

User input 426 may be entered directly onto a map displayed by interactive display 424. User input 426 may include data corresponding to a model element. User input 426 may include data corresponding to a display object. The data may include one or more identifiers that identify a corresponding infrastructure unit. The data may include one or more model element parameters. The data may include connectivity information that identifies one or more neighboring model elements to which a particular element is connected or is to be connected. User input 426 may include a change of an infrastructure unit identifier. User input 426 may include a change of an infrastructure unit parameter. User input 426 may include a change of connectivity information.

User input 426 may include an instruction to add a model element to network model database server 402. User input 426 may include an instruction to delete a model element from database server 402. When user input 426 includes an instruction to add a model element, a user may graphically indicate a position at which to position the element by selecting a geographical position on the map. User input 426 may include one or more instructions to connect the element to another element. Interactive display 424 may communicate user input 426 to network model database server 402 via path 428 to conform model data in database server 402 to changes required by user input 426.

User input 426 may include an instruction to execute a contingency analysis. The instruction may be an instruction to execute the analysis based on a model change displayed by interactive display 424. The instruction may include an instruction to execute the contingency analysis based on a future state of the model. For example, the instruction may include an analysis date. In some embodiments of the invention, network model database server 402 may be configured to provide data to analysis engine 408 only if the data are associated (via geodatabase server 430, as discussed above) with a date that is no later than the analysis date.

User input 426 may include a query of geodatabase server 430. The query may include an instruction to display a representation of a query result using interactive display 424. The query may restrict the result to any model elements associated in geodatabase server 430 with one or more selected parameters. For example, the query may instruct system 400 to display a representation of each 230 megawatt electric power generator scheduled to be placed in service in the network as of a date two years from the date of the query. The query and query result may be communicated along pathway 438.

System 400 may include any suitable query tool for querying a database. In some embodiments, system 400 may include a query tool that is available in a geographic information analysis application such as that sold under the trademark ARCVIEW by Environmental Systems Research Institute, Inc. of Redlands, Calif.

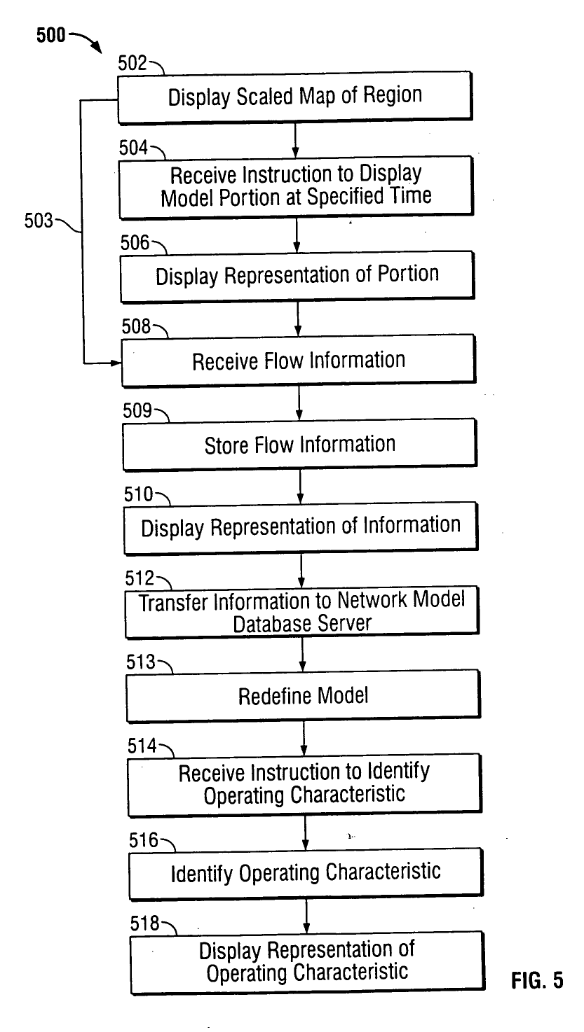

FIG. 5 shows a general flowchart of illustrative steps that may be involved in operating some embodiments of a commodity transport network analysis system in accordance with the principles of the present invention. The steps shown in FIG. 5 are only illustrative and may be performed in any suitable order. In practice, there may be additional steps or some of the steps may be deleted. Some of the steps shown in FIG. 5 may involve providing users with opportunities to interact with the system, performing various processes, or providing various displays. Some of these steps and other steps may be performed by, for example, a client application that is programmed to generate or download screens suitable to provide such opportunities, an Internet browser that downloads suitable pages to provide such opportunities, peer applications, or using any other suitable approach. In an on-line arrangement, access device 102, for example, may be used to run client-based applications, such as a web browser. In non-on-line arrangements, personal computer 112, for example, may run client-based applications.

In on-line arrangements (as shown in FIG. 1), the steps shown in FIG. 5 may be performed by, for example, access device 102, Internet and application server 104, or database server 105, depending on, for example, the processing and storage capabilities of access device 102, the chosen implementation for the markup language documents used, the processing requirements of such operations, or other factors. In non-on-line arrangements (as shown in FIG. 2), such processing may be performed by personal computer 112, remote access device 113, application server 140, database server 105, or distributed among peer applications, depending on the chosen system implementation and the processing requirements of such operations.

For clarity, the following discussion will describe the steps shown in FIG. 5 as being performed by “the system,” which is intended to include any suitable data analysis system, such as, for example, any non-on-line or on-line arrangement suitable for performing the steps. In some embodiments of the invention, the system may have one or more of the features described in connection with one or both of system 400 and interactive display 424 (shown in FIG. 4).

Illustrative process 500 may be used to identify an operating characteristic in a model of a commodity transport network. In response to a user request, the system, in step 502, may display a scaled map of a region on a display. The user may identify the region or subregion by interacting with any suitable graphical user interface control feature such as a drop-down list, a selection box, an application plug-in, and a database query toolbar. The user may select a subregion by outlining the subregion on the map using any suitable user input device. In step 502, the system may display the scaled map.

In step 504, the system may receive an instruction to display at least a portion of the model at a specified time. The portion may be defined by a boundary. The boundary may be a political boundary. The boundary may be a geographic boundary. The boundary may be a geometric boundary. The boundary may be a physiographic boundary. The boundary may be a user-defined boundary. The model portion may be a selection of model elements.

The specified time may be the time at which the instruction is received. The specified time may correspond to a future time, in which the model may have properties that are different from those that may be included in the model at the time the instruction is received. In step 506, the system may display representations of model elements scheduled for interconnection by the specified time.

In step 508, the system may receive flow information. The flow information may be received via a user input device. The flow information may include one or more attributes of an object displayed on the map. Process 500 may proceed along pathway 503 when a user elects to initiate a new model. It will be understood that when an existing model is to be modified, flow information simulates a perturbation of simulated flow through the existing model. When a new model is to be initiated, flow information may include information that provides one or more model elements through which flow may be simulated.

In step 509, the system may store the flow information. In some embodiments, the system may store flow information in a data storage device associated with an interactive display such as interactive display 424 (shown in FIG. 4).

In step 510, the system may display the flow information. In step 512, the system may transfer some or all of the flow information from the storage device to a network model database server such as network model database server 402 (shown in FIG. 4). The system may transfer some or all of the flow information from the storage device to a geographic database server such as geodatabase server 430 (shown in FIG. 4). The flow information may include connectivity information that defines one or more connections between model elements. In step 513, the system may use the connectivity information to redefine how model elements in network model database server 402 are connected.

In step 514, the system may receive a user instruction to identify an operating characteristic in the model. In step 516, the system may identify the operating characteristic. The operating characteristic may be identified by an analysis engine such as 408 (shown in FIG. 4). In step 518, the system may display a representation of the operating characteristic on the display.

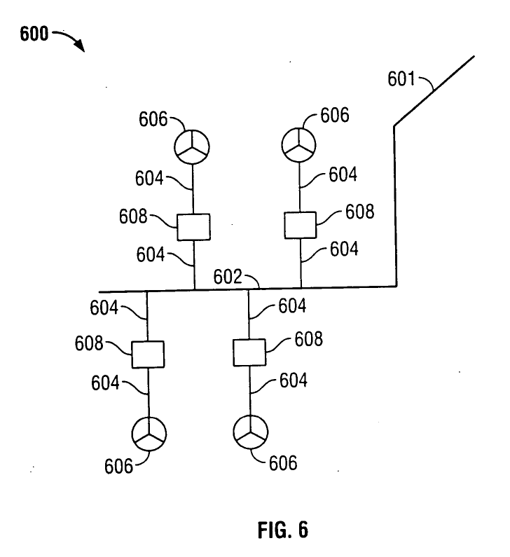

FIG. 6 shows illustrative group 600 of symbolic model elements. Group 600 may represent an electrical power substation in an electric power transmission network. Group 600 may include simulated bus 602 (partially shown), which may be connected to one or more simulated attachment lines 604. Attachment lines 604 may provide simulated electrical communication between simulated electric power generators 606 and simulated bus 602. Branch 601 may provide simulated electrical communication between group 600 model elements and another group of model elements. One or more simulated breakers 608 may be present along attachment lines 604. An attachment lines 604 may include one or more simulated transformers (not shown) for simulating the matching of voltage of a generator to that of a bus.

A model may include one or more simulated loads (not shown). A simulated load may be connected to a bus via a simulated attachment line. One or more simulated transformers may be present along the attachment line for simulating the matching of voltage of the load to that of the bus.

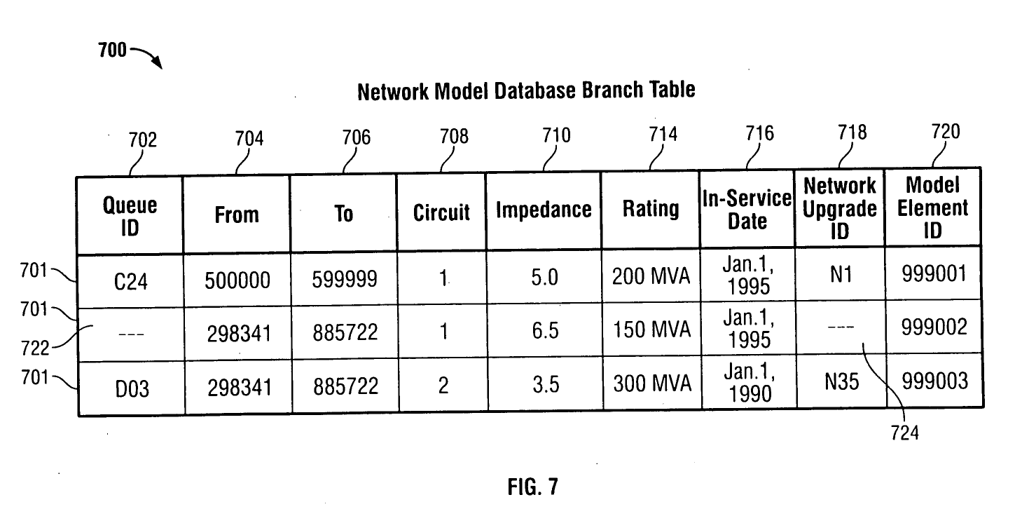

Each of FIGS. 7-11A shows an illustrative table that includes an illustrative sample of data that may be present in network model database server 402. It will be understood that the data shown in the tables is for illustrative purposes only. The data in database server 402 is not necessarily limited to the amount of data or types of data shown in FIGS. 7-11A. Data shown in the tables, or other data that may be present in database server 402, may be stored in any suitable data structures, arranged in any suitable manner and displayed in any suitable manner. The data in FIGS. 7-11A may include one or more parameters associated with infrastructure units. The parameters may be used by analysis engine 408 (shown in FIG. 4) to identify an operating characteristic as shown, for example, at step 516 in FIG. 5. In some embodiments of the invention, a model element may be designated by a parameter as “active” or “inactive” to indicate whether the element should be included in a model analysis.

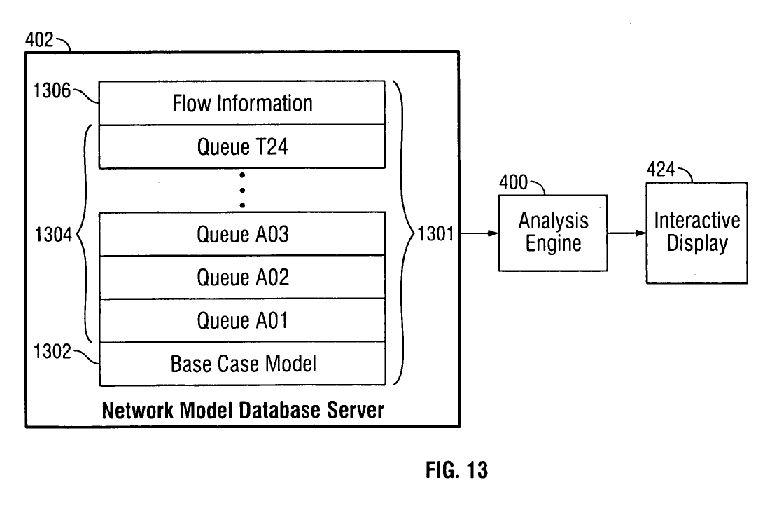

FIG. 7 shows Network Model Database Branch Table 700. Table 700 may include parameters corresponding to one or more branches, such as branch 601 (shown in FIG. 6). Each row 701 of table 700 may correspond to a different branch. Columns 702-720 may correspond to parameters of the different branches. “Queue ID” column 702 may include an identifier of a queue with which a branch is associated. (As used herein, “ID” is an abbreviation of “identifier.”) Cell 722 in column 702 does not include a Queue ID. The branch corresponding to cell 722 is an example of an infrastructure unit that is not associated with a queue. A model element corresponding to such an infrastructure unit is not associated with a queue and may be included in a “base case model.” A base case model may be a set of model elements corresponding to infrastructure units, some or all of which were interconnected without being associated with a queue. (The relationship between a base case model and a queue is shown in FIG. 13.)

Each cell in “From” column 704 may include an identifier of a bus away from which a corresponding branch transports electrical energy. Each cell in “To” column 706 may include an identifier of a bus to which a corresponding branch transports electrical energy. Two busses may be connected to each other via more than one branch. If so, each such branch is identified as being associated with a different circuit. Each cell in “Circuit” column 708 may identify the circuit in which a corresponding branch is present. Each cell in “Impedance” column 710 may include impedance data associated with a corresponding branch. In some embodiments of the invention, the engineering data may include one or more of reactive impedance, real impedance, and charging impedance. Each cell in “Rating” column 714 may include a maximum value of an operating characteristic for a corresponding branch. Column 714 shows a power value in units of megavolt-amps. It will be understood that any other suitable engineering data may be included in the engineering data.

Table 700 may include “In-service date” column 716. Column 716 may show for each branch an in-service date. An in-service date may be a date on which a branch entered into service in a network. An in-service date may be a date on which a branch is scheduled to enter into service.

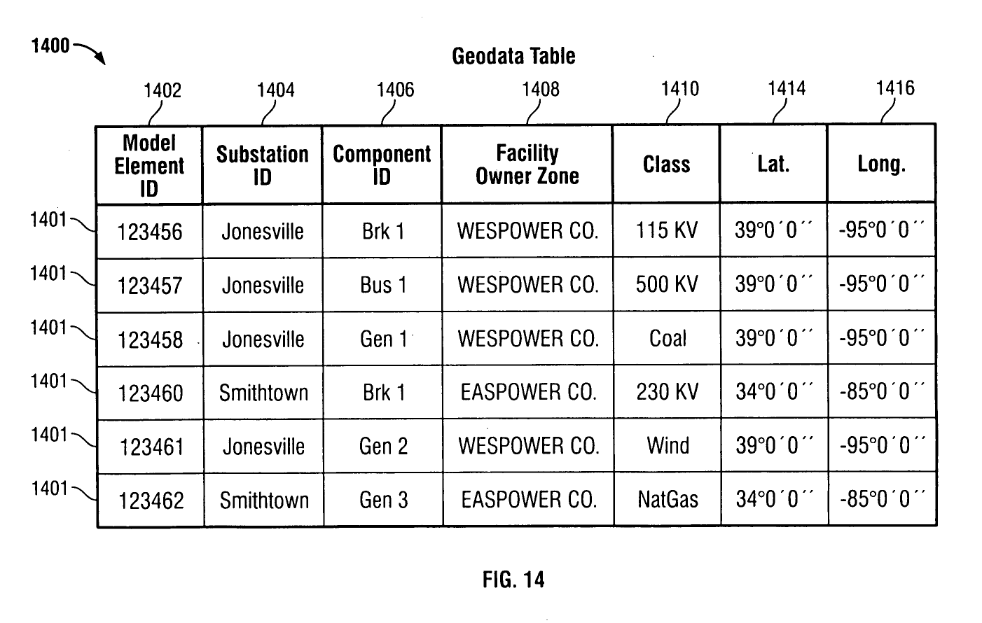

Table 700 may include “Network Upgrade ID” column 718. A “network upgrade,” as used herein, is a group of one or more changes to a network. Each of the changes may be proposed, planned, scheduled, completed or at a different stage of development or completion. A network upgrade may be required to maintain network reliability before the fulfillment of a queued request. A network upgrade may be required for general network maintenance, for example without limitation, to replace an aging infrastructure unit. A network upgrade may be undertaken by a party who owns an infrastructure unit. Column 718 may include an identifier that associates each branch with a network upgrade. More than one branch may be associated with each network upgrade ID. Cell 724 does not include a network upgrade ID because, as discussed above, the branch corresponding to cell 724 is not associated with a queue. “Model Element ID” column 720 may include for a branch corresponding to one of rows 701 a unique identifier that identifies a model element to which the branch corresponds. A data structure corresponding to the model element and having the same model element ID may be stored, for example without limitation, in geodatabase 430. Some or all of the data in the data structure may be shown in a table such as 1400, shown in FIG. 14.

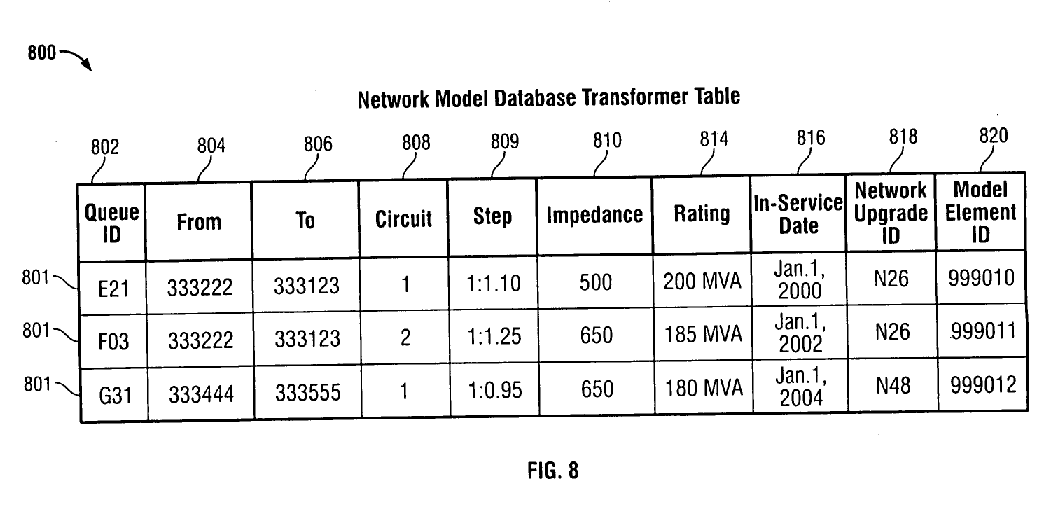

FIG. 8 shows Network Model Database Transformer Table 800. Table 800 may include one or more parameters corresponding to one or more transformers. Each row 801 of table 800 may correspond to a different transformer. Columns 802, 804, 806 and 808 may correspond to columns 702, 704, 706 and 708 of table 700 (shown in FIG. 7), as applied to the transformers of rows 801. A transformer may be present topologically between any two types of infrastructure units. Accordingly, “From” column 804 and “To” column 806 may include identifiers of busses, branches, breakers, generators or any other suitable type of infrastructure unit. “Step” column 809 may include a value of a voltage step produced by each transformer in table 800. Columns 810, 814, 816, 818 and 820 may correspond to columns 710, 714, 716, 718 and 720, respectively, of table 700, as applied to the transformers of rows 801. In some embodiments of the invention, the parameters may include one or more of a number of taps and a tap ratio.

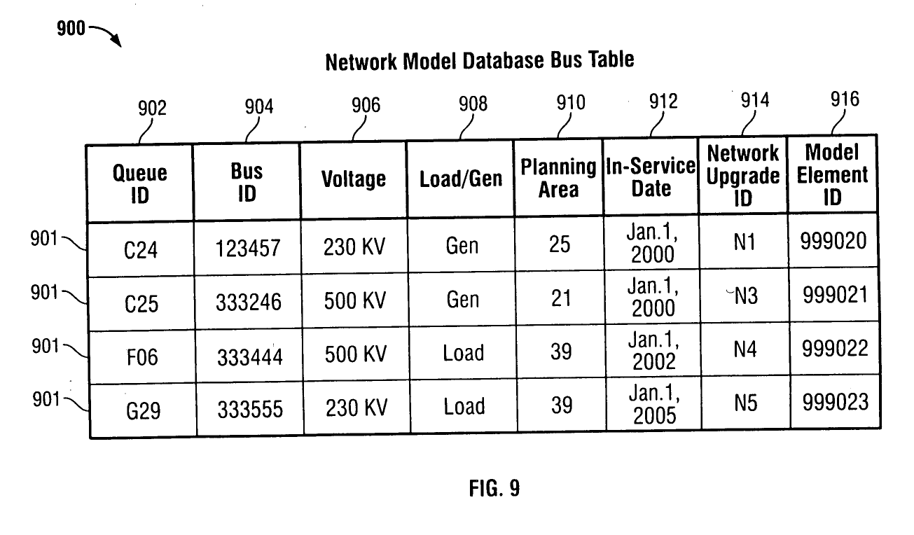

FIG. 9 shows Network Model Database Bus Table 900. Table 900 may include one or more parameters corresponding to one or more busses. Each row 901 of table 900 may correspond to a different bus. Column 902 may correspond to column 702 of table 700 (shown in FIG. 7), as applied to the busses of rows 901. “Bus ID” column 904 may include for a bus an identifier of the bus. “voltage” column 906 may show for a bus the bus operating voltage. “Load/Gen” column 908 may show for a bus whether the bus is attached to one or more loads (such as a tap) or to one or more generators. “Planning Area” column 910 may show for a bus an identifier of a planning area. A planning area, as used herein, is a group of busses having a common geographic location defined by a user. Columns 912, 914 and 916 may correspond to columns 716, 718 and 720, respectively, of table 700, as applied to the busses of table 900.

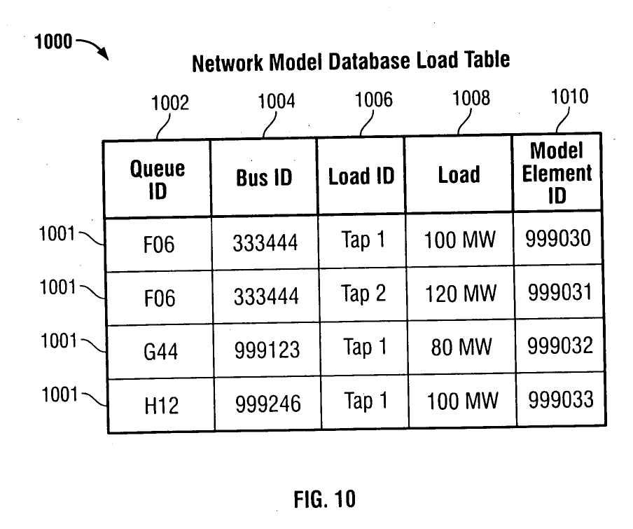

FIG. 10 shows Network Model Database Load Table 1000. Table 1000 may include one or more parameters corresponding to one or more loads. Each row 1001 of table 1000 may correspond to a different load. Column 1002 may correspond to column 702 of table 700 (shown in FIG. 7), as applied to the loads of rows 1001. “Bus ID” column 1004 may include for each load an identifier of the bus to which the load is connected. “Load ID” column 1006 may show for a load an identifier that distinguishes the load from other loads that may be connected to the same bus. “Load” column 1008 may show for a load a value of the power drawn by the load. Column 1008 shows the values in units of megavolt-amps. Column 1010 may correspond to column 720 of table 700, as applied to the loads of table 1000.

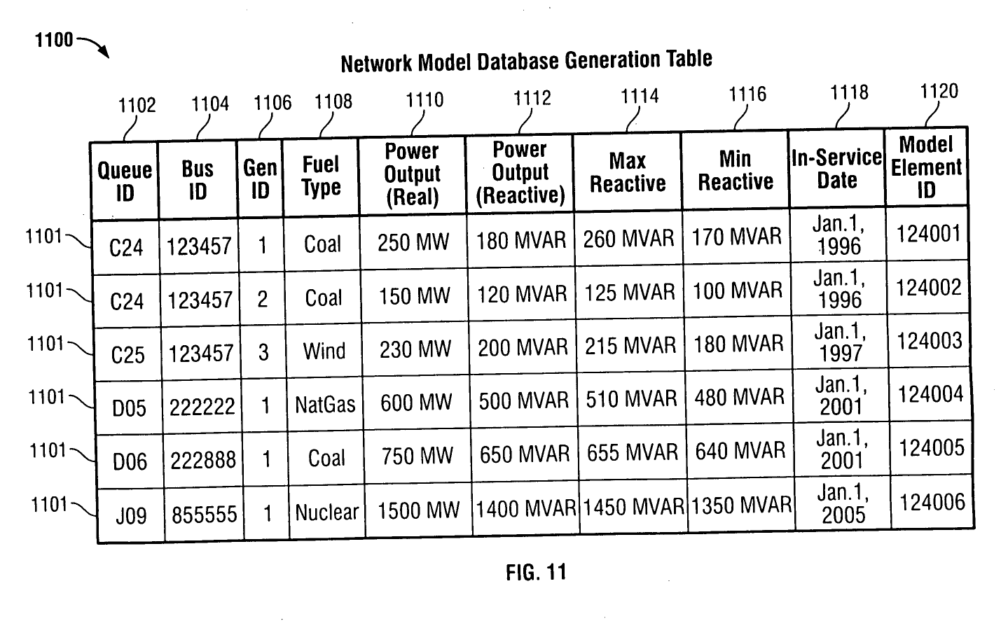

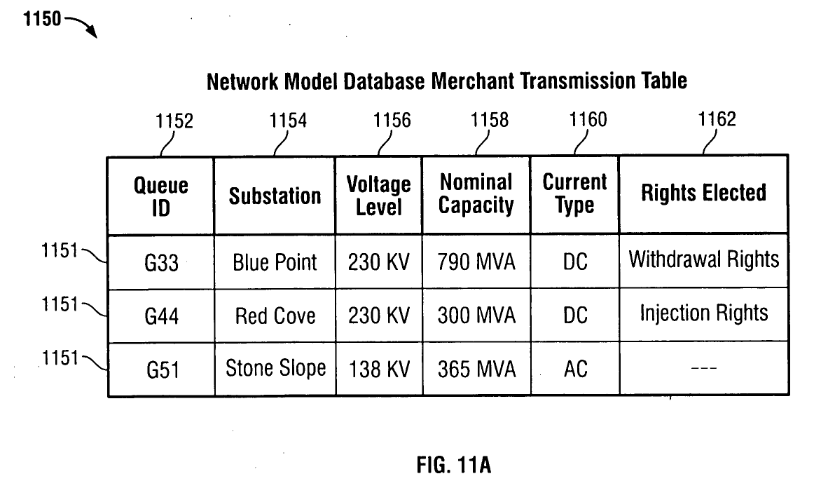

FIG. 11 shows Network Model Database Generation Table 1100. Table 1100 may include one or more parameters corresponding to one or more generation sources. A generation source may include a generator, or any other suitable source of generation. Each row 1101 of table 1100 may correspond to a different generation source. Column 1102 may correspond to column 702 of table 700 (shown in FIG. 7), as applied to the loads of rows 1001. “Bus ID” column 1104 may include for a generation source an identifier of the bus to which the generation source is connected. “Gen ID” column 1006 may show for a generation source an identifier that distinguishes the generation source from other generation sources that may be connected to the same bus. “Fuel Type” column 1108 may show for a generation source a type of fuel used by the source to generate power.

Columns 1110, 1112, 1114, and 1116 may show for a generation source a real power output, a reactive power output, a maximum reactive power output and a minimum reactive power output, respectively. A real power is a real component of a complex power. A reactive power is an imaginary component of a complex power. Columns 1110, 1112, 1114, and 1116 may show power values in megavolts. Megavolts of reactive power are commonly referred to as “VARS”. Columns 1118 and 1120 may correspond to columns 716 and 720, respectively, of table 700, as applied to the generation sources of table 1100.

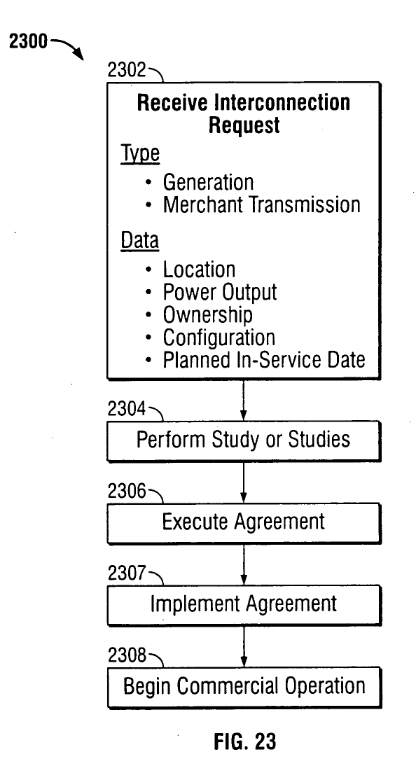

FIG. 11A shows Network Model Database Merchant Transmission Table 1150. Table 1150 may include one or more parameters corresponding to one or more merchant transmission sources. Each row 1151 of table 1150 may correspond to a different merchant transmission source. “Queue ID” column 1152 may include an identifier of a queue with which a merchant transmission source is associated. “Substation” column 1154 may show for a merchant transmission source the name of a substation at which the source is present or is planned to be present. “Voltage Level” column 1156 may show for a merchant transmission source the voltage at terminals at which merchant power is to be injected or from which merchant power is to be withdrawn. “Nominal Capacity” column 1158 may show for a merchant transmission source a power level at which merchant power is to be injected or withdrawn. “Current Type” column 1160 may show for a merchant transmission source a current type—either alternating or direct—for the merchant transmission project. “Rights Elected” column 1162 may show for a merchant transmission project a right that may have been elected by an electrical power merchant. The election may have been made as part of a process such as process 2300 (described below and shown in FIG. 23).

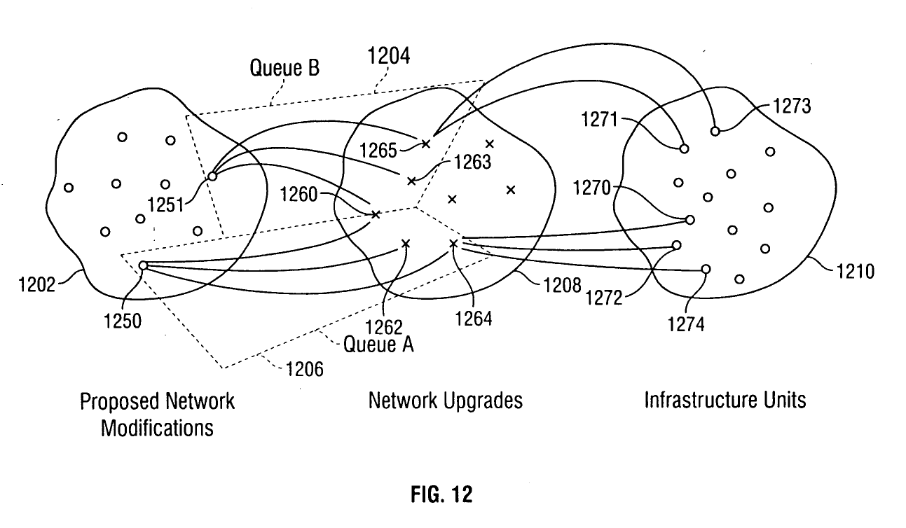

FIG. 12 shows schematically illustrative logical relationships between illustrative proposed network modifications 1202, illustrative queues 1204 and 1206, illustrative network upgrades 1208 and illustrative infrastructure units 1210. Each infrastructure unit 1210 may be represented by an element of a commodity transport network model. Illustrative network modification 1250 may be a proposed new generation source. Network upgrades 1260, 1262 and 1264 may be selected to accommodate additional electrical current that would flow through the network if proposed new generation source 1250 were put in service. Network upgrades 1260, 1262 and 1264 may be selected to accommodate proposed new generation source 1250 based on an analysis that may be performed by a process in accordance with the principles of the invention, for example, using one or more features of system 400 (shown in FIG. 4).

Network modification 1250 and network upgrades 1260, 1262 and 1264 may be grouped together as queue 1206 (“Queue A”). Each of network upgrades 1260, 1262 and 1264 may be defined as the addition, deletion or modification of one or more infrastructure units 1210. Network upgrade 1264 may be defined as the addition, deletion or modification of each of infrastructure units 1270, 1272 and 1274. (For the sake of clarity, definitions of network upgrades 1260 and 1262 with respect to infrastructure units 1210 are not illustrated.)

FIG. 12 shows that queue 1204 (“Queue B”) may include network modification 1251 and network upgrades 1260, 1263 and 1265. Network upgrade 1260 is a member of both queues A and B. The cost of implementing network upgrade may be allocated partially to a party with financial responsibility for network modification 1251 and partially to a party with financial responsibility for network modification 1250. Network upgrade 1265 may be defined as corresponding to addition, deletion or modification of each of infrastructure units 1271 and 1273. (For the sake of clarity, not all definitions of network upgrades 1208, with respect to infrastructure units 1210, are shown.)

FIG. 13 shows schematically shows how an operating characteristic may be identified using all or a portion of a network model. Model sample 1301, which may be established for analysis using analysis engine 408, for example, may include base case model 1302. Parameters corresponding to the infrastructure units that are represented by base case model 1302 may be stored in network model database server 402.

A user, for example using interactive display 424, may select one or more of queues 1304 to include in the model sample. The system may display representations of any elements present in sample 1301. Flow information 1306 may be included in sample 1301. FIG. 13 shows that sample 1301 may be provided to analysis engine 408 (shown also in FIG. 4). Analysis engine 408 may identify an operating characteristic based on sample 1301 (and network load data 404). The operating characteristic may be represented by interactive display 424 on display device 122.

FIG. 14 shows an illustrative example of data that may be present in a database server such as geodatabase server 430 (shown in FIG. 4). FIG. 14 shows Geodata Table 1400 that includes an illustrative sample of data that may be present in geodatabase server 430. It will be understood that the data shown in the table is for illustrative purposes only. The data in geodatabase server 430 is not necessarily limited to the amount of data or types of data shown in FIG. 14. For example, without limitation, geodatabase 430 may include for a model element one or more of an infrastructure unit owner name (which in some instances may be known as a “Transmission Owner”), a state, a county, a township, and a borough.

Data shown in table 1400, or other data that may be present in database server 430, may be arranged in any suitable manner. Data shown in table 1400, or other data that may be present in database server 430, may be displayed in any suitable manner. Data shown in table 1400, or other data that may be present in database server 430 may be stored in any suitable data structures. The data in server 430 may include geographic information associated with model elements. The data in server 430 may include any other suitable parameters associated with model elements or corresponding infrastructure units.

The data in server 430 may include any suitable display data for representing a model element on a display such as 424. The display data may include symbological data that identify a symbol that system 400 is to use to represent the model element. The display data may include topologic data that identify one or more ways in which the model element is to be represented as being connected to another model element in accordance with topologic rules. System 400 may use any topologic rules for representing connectivity between model elements. Topologic rules are well known in geographic information systems.

Each row 1401 in table 1400 may correspond to a different model element. “Object ID” column 1402 may show for each model element in rows 1401 a model element identifier. In some embodiments of the invention, the model element identifier may uniquely identify each element of a model. “Substation ID” column 1404 may show for each model element in rows 1401 a substation identifier that identifies a substation with which the model element is associated. “Model Element ID” column 1406 may show for each model element in rows 1401 an identifier that distinguishes between distinct elements that are of similar types. For example, column 1406 shows that object number 123458 is “Gen 1” (a first generator associated with Jonesville substation) and that object number 123461 is “Gen 2” (a second generator associated with Jonesville substation). “Facility Owner Zone” column 1408 may show for an element in a row 1401 the name of a party, for example a power utility company, that controls a zone in which an infrastructure unit corresponding to the element is present.

“Class” column 1410 may show for an element in a row 1401 class information such as “115 kV,” the class of Brk 1, object number 123456, associated with the Jonesville substation. Although column 1410 shows breaker class information in units of kilovolts, breakers may also be classified by a number of kiloamperes. Generator elements, such as 123458, 123461 and 123462 may be classified, for example, in column 1410 as coal-burning, wind-driven and natural-gas-burning, respectively. “Lat.” and “Long.” columns 1414 and 1416, respectively, may show for each element in rows 1401 a latitude and a longitude corresponding to the element. Although table 1400 shows standard Mercator geodesic latitude and longitude coordinates, any suitable geographic coordinates may be used.

In some embodiments of the invention, a model element may be linked to the scaled geographic map via the latitude and longitude of a substation. In those embodiments, different model elements present in a substation, such as those identified as 123460 and 123462 in table 1400, which are associated with the Smithtown substation, will be associated with the same values of latitude and longitude as each other.

Information in table 1400 may be used in conjunction with a database query tool to define one or more “layers” that correspond to model element parameters. Information from a layer may be displayed on the scaled geographic map (by interactive display 424, shown in FIG. 4, for example). Illustrative examples of layers include without limitation: generators rated at 400 MW; all wind-driven generators; and branch lines rated at 500 MVA; all transmission lines; all busses; all generators; all taps; all switches; all breakers; all wavetraps; all capacitors; all indicators; all phase angle regulators; all substations. Geographic layers including state lines; county lines; water bodies; and topographic contours may be queried independently of model elements.

Model elements in geodata table 1400 may be associated with scheduled events. The scheduled events may be catalogued in schedule server 436 (shown in FIG. 4). In some embodiments of the invention, each event in schedule server 436 may be associated with a network upgrade.

It will be appreciated that an infrastructure unit (such as a transmission line) may extend between two geographic locations that are sufficiently distant that a corresponding model element may be associated with more than one pair of geodesic coordinates. In some embodiments of the invention, such a model element may be associated with a pair of geodesic coordinates corresponding to one end of the infrastructure unit and a pair of geodesic coordinates corresponding to another end of the infrastructure unit. The element may be associated with one or more pairs of geodesic coordinates corresponding to any suitable portion of the corresponding infrastructure unit.

A model element associated with more than one pair of geodesic coordinates may be stored in any suitable data structure, arranged in any suitable manner and displayed in any suitable manner. In some embodiments of the invention, a model element associated with more than one pair of geodesic coordinates may be stored or displayed in a table (not shown) having any of the features of table 1400 in addition to latitude and longitude columns for each pair of geodesic coordinates. It will be understood that a reference herein to table 1400 or its features may encompass one or more tables including a model element associated with more than one pair of geodesic coordinates.

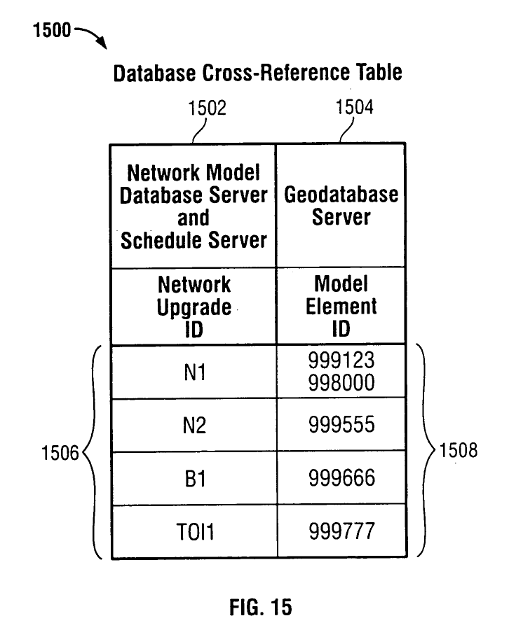

FIG. 15 shows illustrative cross-reference table 1500 that may be used in some embodiments of the invention to link data between network model database server 402, geodatabase server 430 and schedule server 436. It will be understood that table 1500 illustrates one arrangement for linking the data, but that any suitable arrangement may be used. Column 1502 may include network upgrade identifiers 1506. Column 1504 may include model element identifiers 1508. Data representing infrastructure units in network model database server 402 (as shown, for example, FIGS. 7-11A) and data representing events in schedule server 436 (see below, for example) may be tagged with at least a network upgrade identifier. Each model element represented in geodatabase server 430 may be tagged with a model element identifier (for example, as shown in FIG. 14).

Thus, a user may select a geographic position, for example, using a mouse click, on a geographically scaled map displayed by interactive display 424 and request a display of all model elements within a selected distance from the position. The elements may be provided using known geographic information systems methods. Based on the model element identifiers in geodatabase server 430, a table such as 1500 may be used to execute a query based on parameters or any other suitable information from network model database server 402. Based on the model element identifiers in geodatabase server 430, a table such as 1500 may be used to execute a query based on schedule data from schedule server 436.

For example without limitation, a user may query one or more of: all generators to be constructed by a future date; all network upgrades to be in-service by a future date; all network upgrades having a common status and all wind-based generators scheduled to be in-service by a future date.

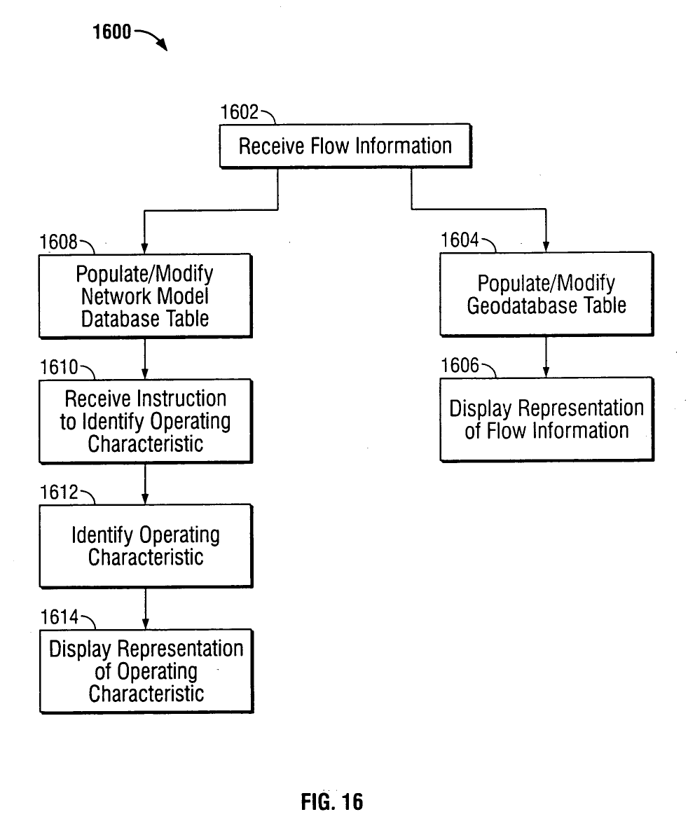

FIG. 16 shows a general flowchart of illustrative steps that may be involved in operating some embodiments of a commodity transport network analysis system in accordance with the principles of the present invention. The steps shown in FIG. 16 are only illustrative and may be performed in any suitable order. In practice, there may be additional steps or some of the steps may be deleted. Some of the steps shown in FIG. 16 involve providing users with opportunities to interact with the system, performing various processes, or providing various displays. Some of these steps and other steps may be performed by, for example, a client application that is programmed to generate or download screens suitable to provide such opportunities, an Internet browser that downloads suitable pages to provide such opportunities, peer applications, or using any other suitable approach. In an on-line arrangement, access device 102, for example, may be used to run client-based applications, such as a web browser. In non-on-line arrangements, personal computer 112, for example, may run client-based applications.

In on-line arrangements (as shown in FIG. 1), steps shown in FIG. 16 may be performed by, for example, access device 102, Internet and application server 104, or database server 105, depending on, for example, the processing and storage capabilities of access device 102, the chosen implementation for the markup language documents used, the processing requirements of such operations, or other factors. In non-on-line arrangements (as shown in FIG. 2), such processing may be performed by personal computer 112, remote access device 113, application server 140, database server 105, or distributed among peer applications, depending on the chosen system implementation and the processing requirements of such operations.

For clarity, the following discussion will describe the steps shown in FIG. 16 as being performed by “the system,” which is intended to include any suitable data analysis system, such as, for example, any non-on-line or on-line arrangement suitable for performing the steps. In some embodiments of the invention, the system may have one or more of the features described in connection with one or both of system 400 and interactive display 424 (shown in FIG. 4).

Illustrative process 1600 may be used to identify an operating characteristic in a model of a commodity transport network. In step 1602, the system may receive flow information. (Step 1602 may correspond to step 508 of process 500 (shown in FIG. 5).) The flow information may be entered via a user input device in conjunction with an interactive display such as 424. Geodatabase server 430 may identify geographic coordinates of a cursor controlled by a user. The geographic coordinates may be included in the flow information.

In step 1604, a geodata table such as 1400 (shown in FIG. 14) may be populated. In some embodiments of the invention, at least a portion of the geodata table may be populated using data received from the user. The data may be received, for example via a dialog box or any other suitable user input feature. In some embodiments, at least a portion of the geodata table may be populated using data automatically identified by the geodatabase server. Data automatically-identified by the geodatabase server may include geographic coordinates. Data automatically identified by the geodatabase server may include the model element ID of a model element displayed on an interactive display and selected by a user using, for example, input device 124. Data automatically identified by the geodatabase server may include any suitable data, including any data that is viewable or selectable on the interactive display and is represented in geodatabase 430. Automatically identified data may include, without limitation, the name of a state, the name of a county, the name of a facility owner, a voltage and a current magnitude.

In step 1606, the system may display, on the interactive display, for example, a representation of the flow information.

In step 1608, one or more network model database tables such as those shown in FIGS. 7-11A may be populated. In some embodiments of the invention, at least a portion of a network model database table may be populated using data received from the user. The data may be received, for example via a dialog box. In some embodiments, at least a portion of the network model database table may be populated using data automatically identified by the geodatabase server. In some embodiments, at least a portion of the network model database table may be populated using data retrieved from geodatabase server 430. In some embodiments, at least a portion of the network model database table may be populated using data retrieved from schedule server 436.

In step 1610, the system may receive an instruction to identify an operating characteristic in the model. In step 1612, the system may identify the operating characteristic using, for example, analysis engine 400. In step 1616, the system may display a representation of the operating characteristic using interactive display 426, for example.

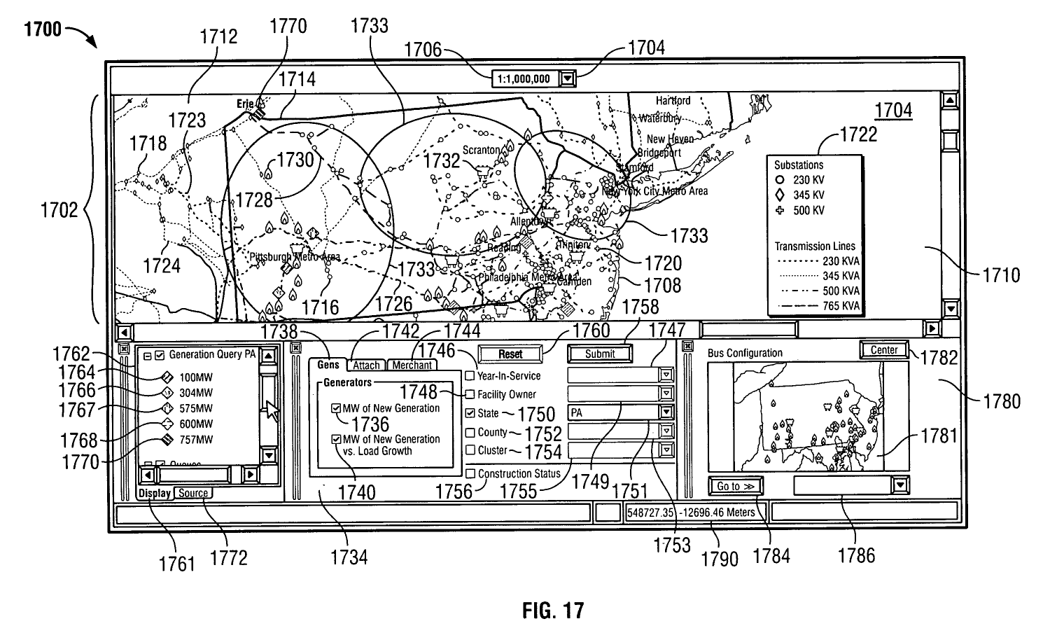

FIGS. 17-22 show illustrative displays that may be provided by a system such as system 400 (shown in FIG. 4). The system may display the illustrative displays, and may display other displays, via a device such as interactive display 424.

A display may include a representation of a geographic feature of a region. A geographic feature may be represented by a data object in a database such as geodatabase 430. A data object may correspond to one or more of a physiographic feature, a political boundary, a geological feature, a topographical feature, a demographic feature, an ecological feature, a man-made structure and any other suitable geographic feature. The data object may include geographic coordinates that correspond to a location of a feature, a boundary, a structure, or any other suitable mappable entity.

System 400 may include any suitable application for displaying a geographically scaled map that includes one or more of the geographic features. System 400 may include any suitable geographic information analysis application, which, in some embodiments of the invention, may be included in interactive display 424, as described above. One example of such an application is the aforementioned ARCGIS, which includes tools for displaying the map, graphically zooming in and zooming out of a displayed region, and bookmarking a region or view of a region for later reference. System 400 may include any suitable application tool for displaying a representation of geographically-referenced information on a geographically scaled map. For example, the application tool may be configured to display a commodity transport model element on the geographically scaled map at a geographically accurate position on the map.

The element may be represented on the map as a display object. The display object may include an attribute corresponding to any suitable model element parameter, including without limitation any of the parameters described in connection with FIGS. 7-11A and 14. The display object may be stored in memory that is operatively associated with interactive display 424, such as storage 129 (shown in FIG. 3). The application tool may be configured to display an indication of an event on the map. The application tool may be configured to display any suitable geographically-referenced information on the map.

System 400 may include any suitable application tool for identifying a user-selected display object on a display such as 424. One example of such a tool is the ARCGIS Identify Tool, which extracts a display object attribute from an attribute table in response to a user selection of the corresponding display object. The display object may be a representation of any of the information that may be present in one or more database servers 402, 430, and 436. The object may be selected by a user using any suitable input device such as 124 (shown in FIG. 3). After identifying the user-selected display object, system 400 may identify a model element identifier associated with the display object and, thus, corresponding information in one or more database servers 402, 430, and 436. System 400 may provide the provide the user with an opportunity to view the corresponding information.

FIG. 17 shows display 1700 that may include portion 1702. Map 1704 may be displayed in portion 1702. Map 1704 may be a scaled geographic map. In FIG. 17, map 1704 is shown for the sake of illustration as a map of a portion of the United States of America, but it will be understood that map 1704 could be a map of any geographic region.

Scale control feature 1704 may be present in display 1700 to control the scale at which map 1704 is displayed. In some embodiments of the invention, scale control feature 1704 may be a feature of a geographic information system tool such as the aforementioned ARCVIEW. Scale control feature 1704 may provide a user with a variety of different scales at which map 1704 may displayed. Scale control feature 1704 may be a drop-down box or any other suitable control feature. Scale display box 1706 may be present to display the current value of the scale of map 1704. In display 1700, the value of the scale is 1:1,000,000. A user may select the value by typing a scale value into box 1706. In some embodiments of the invention, the user may select a scale at which to display map 1704 by dragging a cursor across an area of map 1704 to expand the area to occupy all of portion 1702. Any suitable scale value may be selected.

Map 1704 may show geographic features such as coastline 1708, ocean 1710, lake 1712 and state boundary 1714 (shown in part for the sake of clarity). Map 1704 may include any suitable geographic features, including without limitation roadways and environmentally sensitive areas. User-definable features such as illustrative planning area boundaries 1733 may be shown on map 1704. For electric power transmission planning, a user may wish to define geographically proximal substations as being part of a planning area. A planning area boundary may be defined graphically by tracing the line with a pointer. System may save the boundary as a data structure. System 400 may identify an infrastructure unit within the boundary. System 400 may associate the infrastructure units with the planning area by setting the value of a parameter to an identifier of the planning area. As shown in table 900 (see FIG. 9), each bus in network model database server 402 may be assigned to a planning area.

Map 1704 may show one or more representations of infrastructure units which are illustrated in FIG. 17 as infrastructure units for an electric power transmission grid. In some embodiments of the invention, an infrastructure unit representation may be positioned on map 1704 at a position that corresponds to the actual geographic position of the infrastructure unit. In some embodiments, the infrastructure unit representation may have a size that does not correspond to the scale value of map 1704. System 400 may display a representation of any infrastructure unit for which there is a corresponding model element.

Illustrative substation representations 1716, 1718 and 1720 may be shown on map 1704. Each of representations 1716, 1718 and 1720 represent a group of model elements associated with a substation having a rating. Legend 1722 shows that substation representations such as 1716, 1718 and 1720 correspond to ratings 230 kV (“kilovolt”), 345 kV and 500 kV, respectively. Illustrative transmission line model element representations 1723, 1724, 1726 and 1728 may be represented on map 1704. Legend 1722 shows that the transmission line model element representations correspond to transmission lines that are rated at 230 kV, 345 kV and 500 kV, respectively.

Fuel type representations 1730 and 1732 may be present on map 1704 to represent generation source fuel types. Representation 1730, a flame, may represent natural gas. Representation 1732, a coal car, may represent coal. Other fuel type representations, not shown, may represent any other generation source fuel type, such as nuclear, wind and hydroelectric.

Display 1700 may include query definition portion 1734 that may be used to query a database such as one or more of network model database server 402, geodatabase 430 and schedule server 436. Checkbox 1736 at tab 1738 may be used to define a query of megawatts of “new generation”. “New generation” may be defined as any generation source that is planned, but has not yet entered into service in the power transmission grid.

Checkbox 1740 may be used to instruct the system to display a graph, such as a graph of load versus time, generation capacity versus time, generation capacity versus load or any other suitable graph. Display 1700 may include a control feature that provides a user with an opportunity to instruct the system to display one or more graphs (not shown) of any data that may be present in network model database server 402, geodatabase server 430 or schedule server 436. System 400 may include any suitable tool for generating the graph. In some embodiments, system 400 may include a tool such as the aforementioned CRYSTAL REPORTS.

Display 1700 may include, for example one or more query checkboxes related to attachment facility infrastructure units (such as branches and transformers) at tab 1742. Display 1700 may include, for example one or more query checkboxes related to merchant transmission at tab 1744.

Display 1700 may include any suitable query limit control features. For example, display 1700 may include checkboxes 1746-1754 to provide a user with an opportunity to limit the query defined by checkbox 1736. Checkboxes 1746, 1748, 1750, 1752 and 1754 may limit the query to one or more of a new generation associated with a selected in-service year, a selected facility owner, a selected state, a selected county and a selected planning area. Corresponding text input/drop down control features 1747, 1749, 1751, 1753 and 1755 may be used to select values of the in-service year, facility owner, state, county and cluster, respectively. Checkbox 1756 may be used to limit a query based on the construction status of an infrastructure unit. It will be appreciated that any suitable control features may be present in display 1700 to query one or more of database servers 402, 430 and 436. It will be appreciated that any of the results of such a query may be displayed on map 1704 using geographic coordinates present in geodatabase server 430.

“Submit” radio button 1758 may be configured to enable a user to instruct the system to execute a query defined in query definition portion 1734. The system may display the query results on map 1704. “Reset” radio button 1760 may be configured to enable a user to remove the query results from map 1704. “Reset” radio button 1760 may remove user-input from query definition portion 1734.

Display 1700 may include query layer legend 1762 (at “display” tab 1761), which may show one or more symbols that may correspond to a category that may be present in a query result. The category may be referred to as a “layer.” The result from the illustrative query defined in query definition portion 1734 includes generation sources having more than one value of real power output (see, for example, column 1110, table 1100, shown in FIG. 11). Legend 1762 shows symbols such as 1764, 1766, 1767, 1768 and 1770 that may be used to designate different layers of power output associated with the generation sources. Generation sources in a layer may optionally be displayed by selecting the layer in query layer legend 1762. For example, new generation source 1770, in the 757 MW (“megawatt”) layer (reference numeral 1750) is shown near Erie. In some embodiments of the invention, each of the layers in legend 1762 may be individually selectable by a user for display in portion 1702.

Source tab 1772 in query layer legend provide a user with an opportunity to identify a location within a database of a data structure corresponding to a display object displayed in display 1700. The data base location may be a file. In some embodiments of the invention, a correspondence between the location and the display object may be provided by an application such as the aforementioned ARCVIEW.

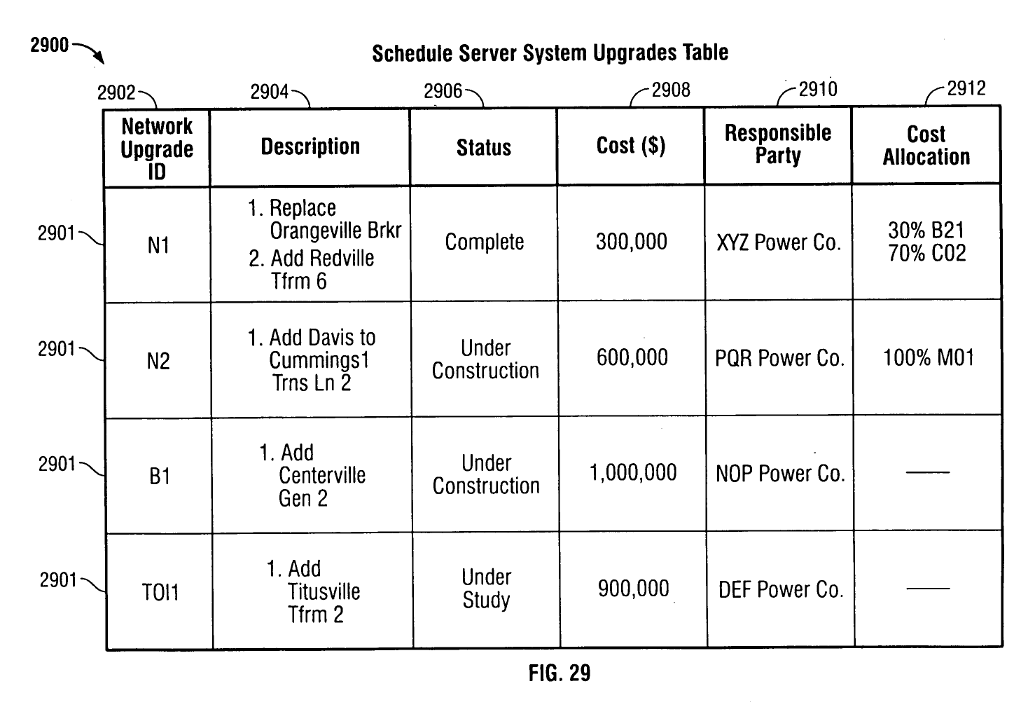

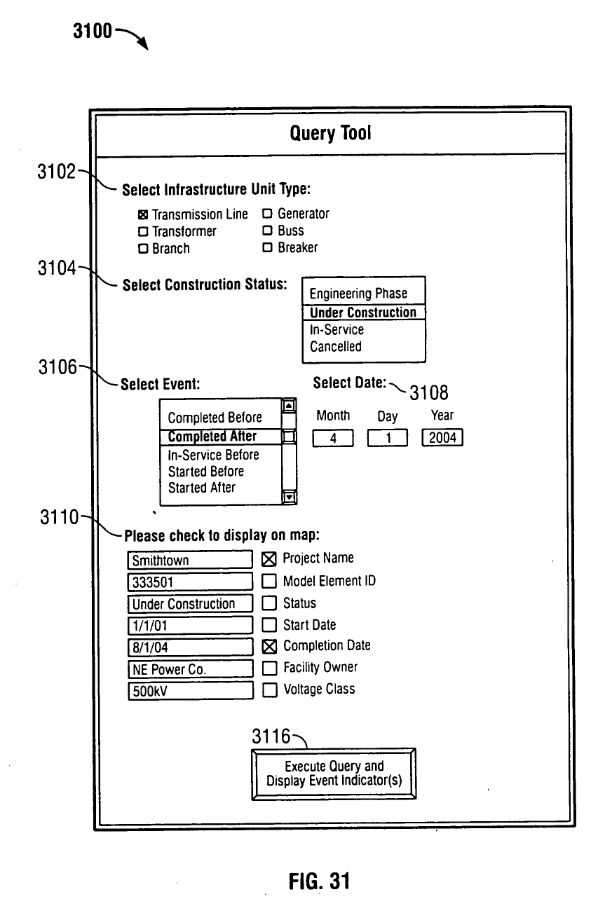

It will be understood that although FIG. 17 shows an exemplary database query defined by new generation and state (at checkbox 1750), any of the data fields in network model database server 402, geodatabase 430 and schedule server 436 may be used to define a query. Some of those fields are illustrated in the tables of FIGS. 7-11A and 14-15. Some of those fields are illustrated in the tables of FIGS. 29 and 31, which include data that may be present in schedule server 436 and are discussed below.

Overview frame 1780 may be present in display 1700 to provide overview map 1781 of a geographic region that encompasses the region displayed in portion 1702. “Center” radio button 1782 may be present to enable a user to define the center of overview map 1781 as being coincident with the center of map 1704. “Go to” radio button and input user input/drop down control feature 1786 may be present to enable a user to define a selected location as the center of overview map 1781. Linear coordinates 1790 may be present to show a position of a pointer, such as a user input device pointer, on display 1700.

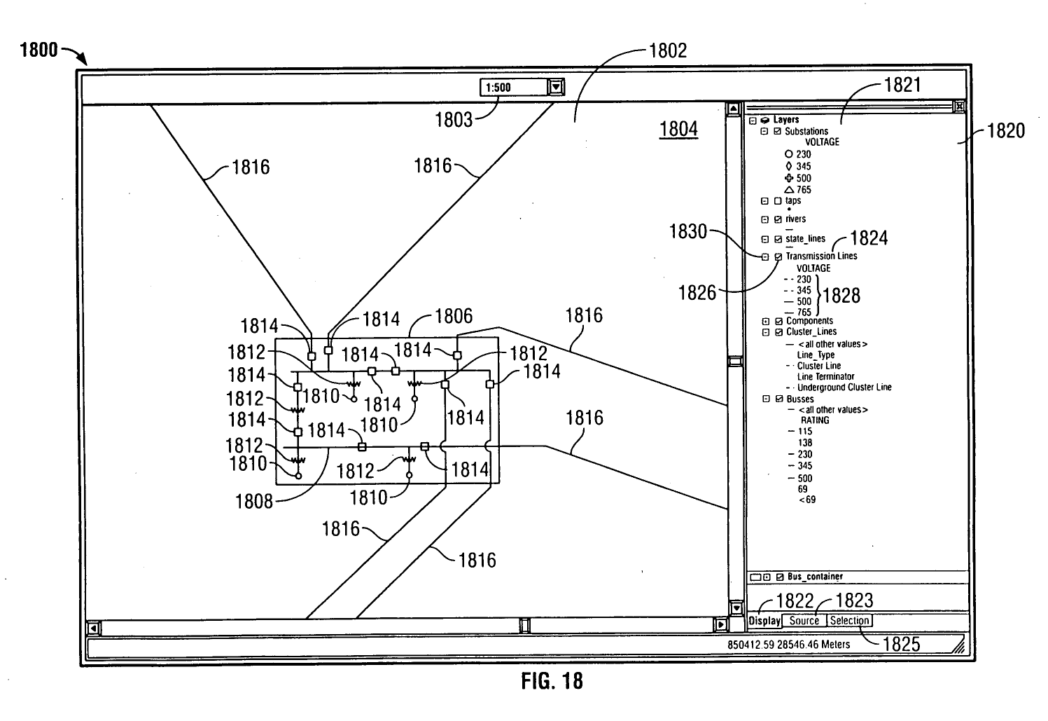

FIG. 18 shows display 1800, which may include frame 1802, which may show a view of map 1804 (which may show features similar to those shown on map 1704) at a scale of 1:500, as shown in user input/drop down control feature 1803. Frame 1802 may be referred to as a “one-line diagram.” Substation representation 1806 may be shown on map 1804. Substation representation 1806 may include bus representation 1808, generator representations 1810, transformer representations 1812 and breaker representations 1814. Branch representations 1816 may connect to one or more portions of substation 1806. FIG. 18 shows branch representations connected to more than one of breaker representations 1814.

Frame 1820 may include any suitable geographical information system feature. For example, frame 1820 may include interactive legend 1821 that may show at display tab which layers are toggled for display on map 1804. Model elements that are in layers toggled for display, but are not displayed on map 1804 at the scale selected in control feature 1803 may be displayed at a different scale or at a location on map 1804 that is outside of frame 1802. A layer such as transmission line (or “branch”) layer 1824 may be toggled on and off for display by a user using checkbox 1826. In some embodiments of the invention, sub-layers such as each of operating voltage layers 1828 may be toggled on and off. Illustrative list-expansion feature 1830 may be used to display or hide sub-layers in frame 1820.

Source tab 1823 may provide functionality analogous to that provided by tab 1722 (shown in FIG. 17).

Selection tab 1825 may provide the user with an opportunity to make a layer available for editing. Selection tab 1825 may provide the user with an opportunity to make a layer available as the subject of a query.

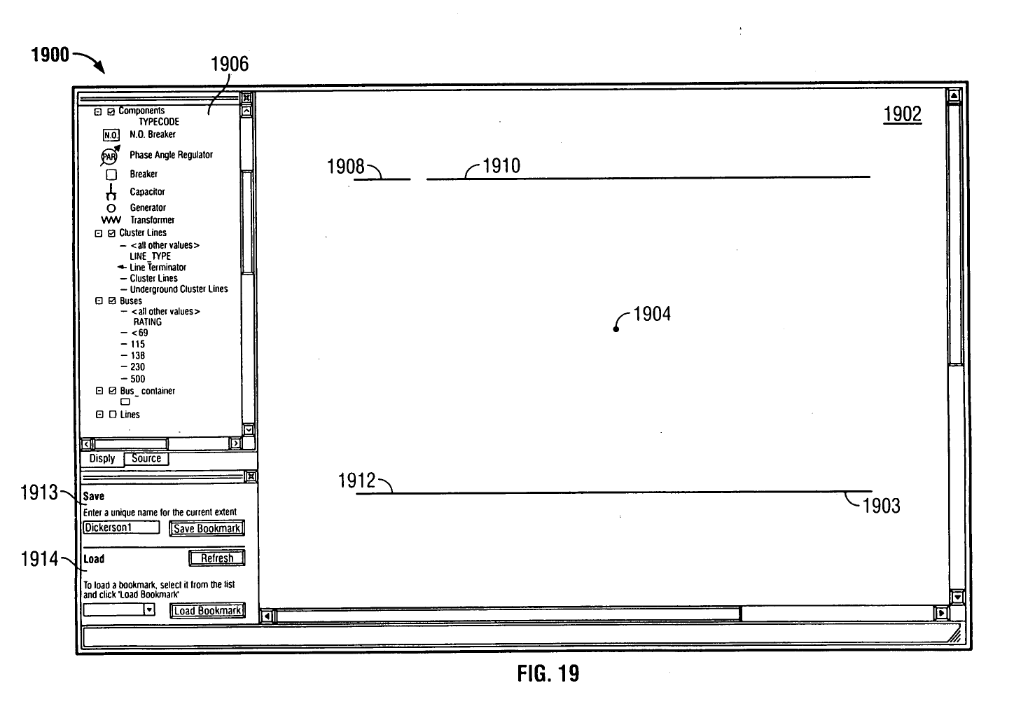

FIGS. 19-22 show illustrative views that may be displayed on a display such as interactive display 424 when a model of a power transmission grid is edited by the interaction of a user with interactive display 424. System 400 may include any suitable software tool for adding a display object to, deleting a display object from, and editing a display object in, the display. When adding an object, the user may use one or more of the tools to graphically connect the object to an object already present in the display. In some embodiments of the invention, the tool may be based on, for example, an ARCGIS Line Connection Tool. The tool may be configured to follow user-defined topological rules. Examples of tools that may be present in system 400 include without limitation: a bus display object creation tool, a branch display object creation tool, a generator display object creation tool and a circuit breaker display object creation tool. A user may use an editing tool to input flow information system 400. In some embodiments, flow information may be automatically identified by an editing tool.

Some embodiments of the invention may include a display object library. The library may provide a user with an opportunity to select for addition to a display a display object corresponding to a model element. The display object may include one or more parameters corresponding to those shown in one or more of FIGS. 7-11A and 14 or any other suitable parameter. For example without limitation, the library may include one or more of a three-breaker ring display object, a breaker-and-a-half ring bus display object, a generator-breaker-step-up-transformer display object. (It will be appreciated that multiple display objects may be used to represent a combination of model elements.)

In some embodiments of the invention, the library may provide drag-and-drop functionality that may allow a user to input flow information by dragging a display object from the library to a location on the display and dropping it into position adjacent a display object that is already present in the display. In those embodiments, the system may automatically connect the dropped display object to the already-present display object.

System 400 may update a network model such as that stored in database server 402 to include information corresponding to one or more of the dropped display object and the connection between the display objects. A tool may be configured to conform to topological rules. A topological rule may require that display objects be interconnected on the display in a manner that is suitable for the infrastructure units that the display objects represent. A rule may require, for example without limitation, that if a display object representing a 500 kV transmission line is to be connected to a 230 kV transmission line, a transformer display object must be connected between the two transmission lines. A rule may prohibit, for example without limitation, the connection of a display object representing a 230 kV breaker to a 500 kV substation. The tool may incorporate any suitable electrical engineering principles.

In some embodiments of the invention, editing processes may be run on an application server such as server 104 (FIG. 1). In some embodiments of the invention, editing processes may be run on an application server such as server 140 (shown in FIG. 2). In some embodiments of the invention, editing processes may be run on a user access device such as that illustrated in FIG. 3.

FIG. 19 shows view 1900 of an initial stage of adding substation representation 1903 to an electric power transmission grid model. Using known geographic information systems methods, a user may provide user input such as user input 426 to system 400. The user input may correspond to flow information such as that involved in step 508 of process 500 (shown in FIG. 5). For example, a user may identify location 1904 on geographic map 1902 at which to add the substation. The user may provide user input by selecting an object from object list 1906 and, using known geographic information system methods, selecting a location on map 1902 at which to place the object. FIG. 19 shows bus display objects 1908, 1910 and 1912 that have been placed near location 1904.

Frame 1913 may be present to provide tools for saving part or all of the simulated substation for future editing. Frame 1913 may provide tools for loading previously saved model elements.

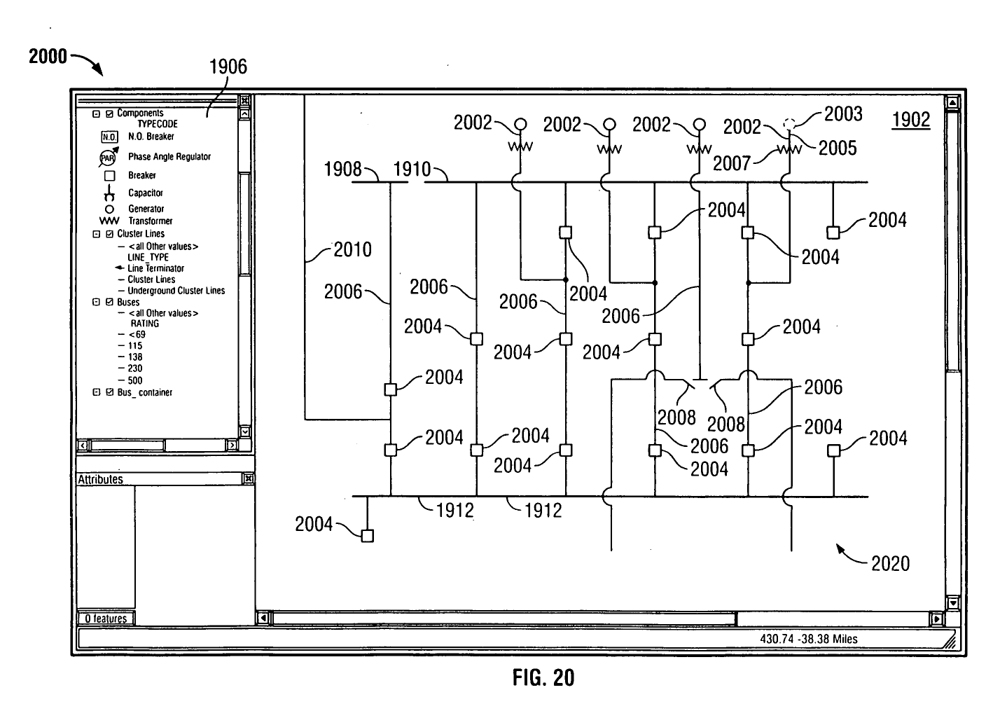

FIG. 20 shows view 2000 of an advanced stage of “building” the simulated substation of FIG. 19 and adding it to the model. Generator-transformer pair display objects 2002, attachment line display object 2005 and transformer display object 2007, simulated breaker display objects 2004, bus display objects 2006 and switch display objects 2008 have been connected to bus display objects 1908, 1910 and 1912 (shown also in FIG. 19). Generator display object 2003 is shown in broken line to indicate that it has not yet been added to display 2000. The simulated substation has been attached to a different simulated substation via simulated branch 2010.

The addition to the model of a new generator corresponding to generator display object 2003 (shown in FIG. 20) will now be described with reference to simulated substation 2020. User input such as 426 may be provided by a user to the system using one or more of the aforementioned tools, text input and graphical interaction with an interactive display such as 424. For example, a user may use one or more of the tools to display generator display object 2003 on display 2000. System 400 may assign a model element ID (such as those shown in geodata table 1400 (shown in FIG. 14)) to the new generator and create a record in a table such as geodata table 1400 for a new generator model element. In some embodiments of the invention, fields in columns 1404, 1406, 1408, 1410, 1414 and 1416 corresponding to the new generator model element may be populated automatically using data from the editing tools. In some embodiments, one or more of the fields may be populated using user input such as user input 426 that may be keyed in manually.

It will be appreciated that a narrowly defined data object shown in list 1906 will enable an editing tool to populate a data table more completely than a broadly defined data object. For example, in some embodiments, a “generator” may be selectable on list 1906. In those embodiments, it would be necessary for a user to input data for columns such as 1108 (“Fuel Type”) in table 1100. In some embodiments, list 1906 may include a selectable generator display object for each of multiple fuel types. A user could thus select “Generator Fuel Type: Coal” from list 1906. The editing tools could thus automatically populate table 1100 with fuel type information.

System 400 may create a record in network model database generation table 1100 corresponding to the new generator model element and display object 2003. The new generator model element may be identified in table 1100 by the bus to which it is attached. The bus ID (column 1104 of table 1100) may be identified automatically by the editing tool. The bus ID may be provided by a user via interactive display 424.

In some embodiments of the invention, one or more of the fields in columns such as 1102, 1106, 1108, 1110, 1112, 1114, 1116, 1118 and 1120 corresponding to the new generator model element and display object 2003 may be populated using data received by the editing tool. In some embodiments of the invention, one or more of the fields in columns such as 1102, 1106, 1108, 1110, 1112, 1114, 1116, 1118 and 1120 corresponding to the new generator model element and display object 2003 may be populated using data received as user input 426. In some embodiments of the invention, one or more of the fields in columns such as 1102, 1106, 1108, 1110, 1112, 1114, 1116, 1118 and 1120 corresponding to the new generator model element and display object 2003 may be populated using data received from geodatabase server 430. In some embodiments of the invention, one or more of the fields in columns such as 1102, 1106, 1108, 1110, 1112, 1114, 1116, 1118 and 1120 corresponding to the new generator model element and display object 2003 may be populated using data received from schedule server 436.

It will be appreciated that the addition of other model elements, such as a simulated branch, a simulated transformer, a simulated bus, a simulated load, and any of the simulated model elements listed in list 1906 is analogous to the addition of a generator. It will be further appreciated that whereas generator 2003 would be associated in network model database generation table 1400 with a bus, a newly added simulated bus would be referenced in network model database bus table 900 to a simulated branch and a newly added simulated branch would be referenced in network model database branch table 700 to two simulated busses.

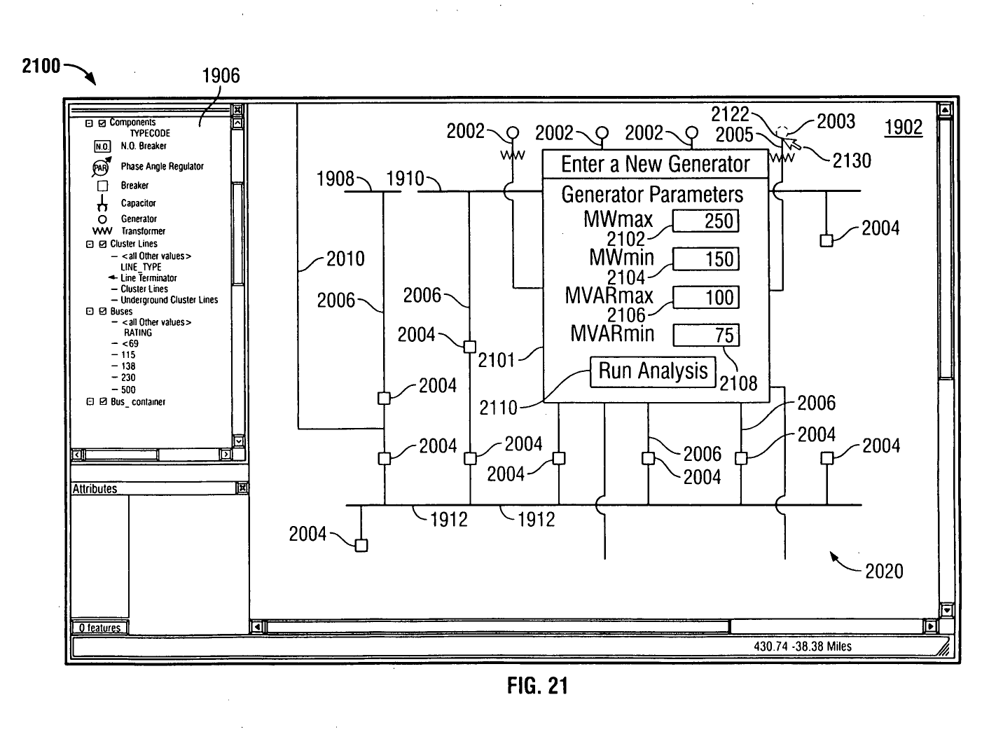

FIG. 21 shows display 2100 that includes an illustrative example of user input feature 2101 that a user may use to provide user input to the system in connection with generator display object 2003. Feature 2100 may be displayed to the user, for example, after the user selects a generator object from list 1906 and indicates, for example using pointer 2130, a location such as 2122 on map 1902 at which the generator is to be placed. The location may be coincident with a portion of a display object such as attachment line display object 2005. The editing tool may identify one or both of the location and the model element.

The editing tool may identify the geometry of a possible contiguous connection between generator display object 2003 and attachment line display object 2005. The editing tool may identify the geometry based on known rules for connecting objects in geographic information system displays. In some embodiments of the invention, the editing tool may prompt the user to select a geometry. For example, the system make prompt the user to select an end-to-end connection, a side-to-side connection or an end-to-side connection.

System 400 may use feature 2101 to receive user input that is not automatically identified by the editing tool. Feature 2101 may prompt the user to enter generator parameters. Input boxes 2102, 2104, 2106 and 2108, for example, may be use to prompt the user to enter maximum operating power output (“MWmax”), minimum operating power output (“MWmin”), maximum reactive power output (“MVARmax”) and minimum reactive power output (“MVARmin”), all in suitable units, such as megawatts. The editing tool may populate table 1100 columns 1110, 1112, 1114 and 1116 (in a row corresponding to generator display object 2003) with data received from input boxes 2102, 2104, 2106 and 2108, respectively.

Feature 2101 may include “Run Analysis” process control feature 2110. Feature 2110 is illustrated as a radio button, but any suitable user interface control feature may be used. The user may use feature 2110 to instruct system 400 to perform analysis such as that in process 500, step 516 (shown in FIG. 5). System 400 may perform the analysis and provide the user with a graphical result. For example, a representation of an overloaded simulated network component, such as a transmission line or a breaker, may be shown in bold. A short-circuited breaker may be shown, for example, in bold.

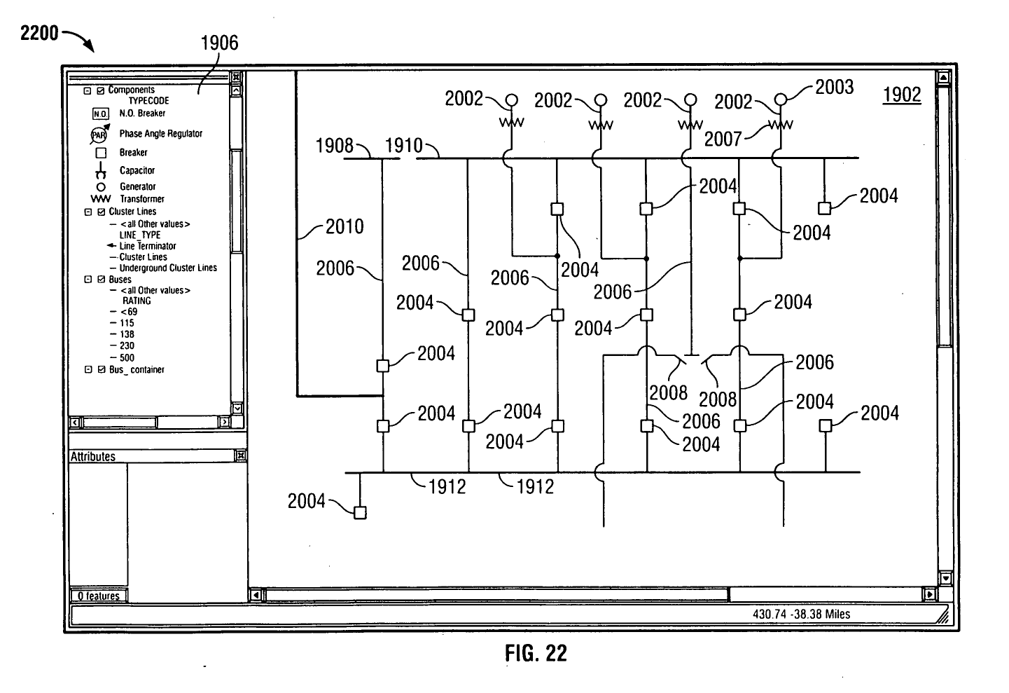

FIG. 22 shows display 2200, which may include an illustrative graphical result of system 400 analysis. Display 2200 shows map 1902 with generator display object 2003 shown in a solid line to indicate that generator 2003 has been included in the model. Display 2200 shows branch line 2010 in exaggerated form to show that system 400 identified an operating characteristic in branch line 2010. The operating characteristic may be any type of operating characteristic, including without limitation one of those described above in connection with calculated values of operating characteristics.

In some embodiments of the invention, an exaggerated form may be an over-sized representation of a model element. In some embodiments of the invention, an exaggerated form may be a representation of a display object in a bright color. In some embodiments of the invention, system 400 may display an operating characteristic label (e.g., “Overcurrent Condition”) adjacent a display object corresponding to a model element in which the operating characteristic is identified. In some embodiments, system 400 may display an operating characteristic value (e.g., “1,000 Amperes”) adjacent a display object corresponding to a model element in which the operating characteristic is identified. In some embodiments of the invention, system 400 may display an operating characteristic graphic indicator (for example without limitation a highlighted region surrounding or coincident with a model element representation, an icon indicating a critical condition, or any other suitable indication of an operating condition) adjacent or overlapping with a display object corresponding to a model element in which the operating characteristic is identified.

FIGS. 23-27 show illustrative steps that may be involved in developing a commodity transport network such as an electric power transmission grid. Developing a commodity transport network may involve taking steps to upgrade a network to accommodate the requested interconnection of a new power generation facility. The steps may influence the choice a user may make regarding which portion of a model to analyze using system 400. For example, the steps may influence which queues to include in a model sample, such as model sample 1301.

FIG. 23 shows overview interconnection process 2300. In step 2302, an interconnection entity, which may be one or more of a private company, a government organization, a non-governmental organization, an electric utility, a facility owner (such as a transmission owner), and a regional facilities owner (such as a regional transmission organization and an independent system operator) may receive a request for interconnection (of a generator, e.g.) from a second entity. The second entity may be one or more of a generation equipment owner, a transmission infrastructure owner, a facility developer, a governmental body and an independent power producer. One or more of the steps in process 2300 may be taken by one or more of the interconnection entity and a second entity. The request may be assigned a queue identifier such as those shown in FIGS. 7-12.

As shown in FIG. 23 at step 2302, the request may be a request for interconnection of an infrastructure unit with the grid. The request may include a “Type”. The Type may specify a type of infrastructure unit such as a generator or a merchant transmission source. The request may include “Data”, which may include a location of the requested interconnection, a proposed power output, a name of an owner of equipment providing the power, a planned in-service date and any other suitable data. In step 2304, the interconnection entity may perform one or more studies. A study may identify an engineering consequence of a proposed request. (The engineering consequence may include the identification of an operating characteristic.)

In step 2306, parties may execute one or more agreements. The parties may include the interconnection entity. The parties may include one or more second entities. The parties may include the infrastructure unit owner. An agreement may be a contract. An agreement may define an obligation of one or more of the parties to perform an act by an identified date.

In step 2307, an agreement may be implemented. In step 2308, commercial operation of the infrastructure unit may begin. Any step in process 2300 may involve photographing one or more of a site, a facility, an infrastructure unit or any other location or object that is suitable for the step.

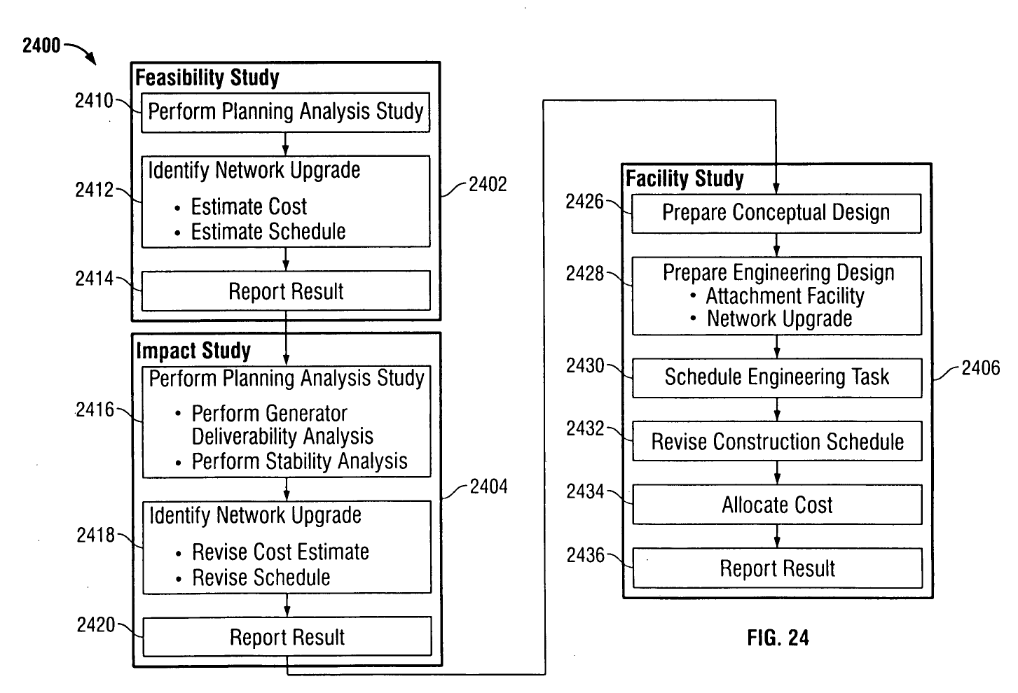

FIG. 24 shows illustrative details that may be involved in performing step 2304. A Feasibility Study may be performed in step 2402. The Feasibility Study may include step 2410, in which a planning analysis study may be performed. The interconnection request in step 2302 of process 2300 may be a subject of the planning analysis study. The planning analysis study may include engineering analysis of the transmission grid model. The analysis may identify an operating characteristic that exceeds an established value of the characteristic for an infrastructure unit. The established value may be an operating limit based on an infrastructure unit equipment rating. The analysis may identify an operating characteristic that does not meet a threshold value of the characteristic for an infrastructure unit. The threshold value may be an operating minimum based on an infrastructure unit equipment rating.

In step 2412, a network upgrade may be identified. The network upgrade may be identified, for example, by using system 400 to identify an operating characteristic after adding a requested generation facility to a model, for example, as shown in FIGS. 21-22. A cost of the interconnection request may be estimated. A cost of a network upgrade required by the interconnection request may be estimated. An estimated schedule may be established. The schedule may be a schedule of tasks related to any of the steps in process 2300. In step 2412, a result of the planning analysis study may be reported to, for example, one or more of an interconnection customer, a transmission owner, an infrastructure unit owner, a regional transmission organization and an independent system operator.

In step 2404, an Impact Study may be performed. The Impact Study may include performing a planning analysis study (in step 2416). Step 2416 may include performing a generator deliverability analysis. The generator deliverability analysis may include quantifying the ability of a generator to deliver electric power to one or more loads.

Step 2416 may include performing a stability analysis. The stability analysis may include identifying an operating characteristic in a network model element. The stability analysis may include identifying a change in an operating characteristic in the model element. The change may be caused by the interconnection of a model element corresponding to the generator interconnection request with another model element. The change may be in the model element corresponding to the generator interconnection request.

In step 2418, a network upgrade may be identified based on the planning analysis study in performed in step 2416. Step 2418 may include revising an estimate of a cost of the network upgrade. Step 2418 may include revising a schedule that may include a task associated with implementing the network upgrade. In step 2420 a result of the planning analysis study may be reported to one or more of the parties listed in connection with reporting step 2412.

In step 2406, a Facility Study may be performed. The Facility Study may include (at step 2426) the preparation of a conceptual design of a facility. The facility may be associated with the interconnection request. The facility may be a network upgrade. The facility may be associated with a generation facility. The facility may be a transmission facility. The facility may be a merchant transmission facility. The facility may be an attachment facility. An attachment facility may include one or more infrastructure units that are required to attach a first infrastructure unit to a second infrastructure unit. The facility may include one or more of any of the infrastructure units discussed above, for example, in FIGS. 17-21. In step 2428, an engineering design may be prepared for the facility.

In step 2430, a schedule for an engineering task may be established. The task may include one or more of producing a substation layout, designing a substation, designing a substation control system, and designing a substation communication system. In step 2432, a construction schedule, such as one established in one or more of steps 2402 and 2406, may be revised. In step 2434, a cost of fulfilling the interconnection request may be allocated to one or more of the parties. For example, a first portion of a cost of an upgrade that is common to two queues (for example, upgrade 1260, shown in FIG. 12) may be allocated a first party. A second portion of the cost may be upgraded to a second party.

In step 2426, a result may be reported to one or more of the parties listed in connection with reporting step 2412.

One or more analyses, for example without limitation one of the analyses described in connection with process 2400 may involve calculating a transmission line resistance value from a transmission line material property and a transmission line length. The material property may be a resistivity that may be stored in a database such as that in server 402 (shown in FIG. 4). The transmission line length may be determined by a system such as 400 using any suitable geographic information analysis tool or application such as the aforementioned ARCGIS. The geographic information analysis tool may calculate a transmission line length based at least partially on geographic coordinates of the transmission line end points. The geographic information analysis tool may calculate the length based at least partially on the curvature of a display object representing the transmission line in a display such as 424.

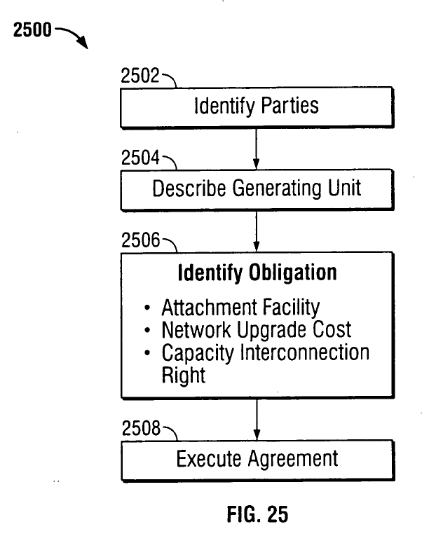

FIG. 25 shows illustrative details that may be involved in performing step 2306 (shown in FIG. 23). Process 2500 may be used to develop and execute an agreement. The agreement may be any suitable contract. The agreement may be an Interconnection Service Agreement. In step 2502, the parties to the agreement may be identified. In step 2504, an infrastructure unit that is the subject of the interconnection request may be identified. The infrastructure unit may be any type of infrastructure unit, although process 2500 involves the requested attachment of a generator for illustrative purposes.

In step 2506, an obligation of a party may be identified. The obligation may be an obligation to construct an attachment facility. The obligation may be to provide funds for the construction of an attachment facility. The obligation may be to provide funds for an upgrade cost. The obligation may be an obligation to produce an identified amount of power using the generator. The obligation may be an obligation to produce an identified amount of power using the generator at an identified time. In step 2508, the agreement may be executed by the parties.

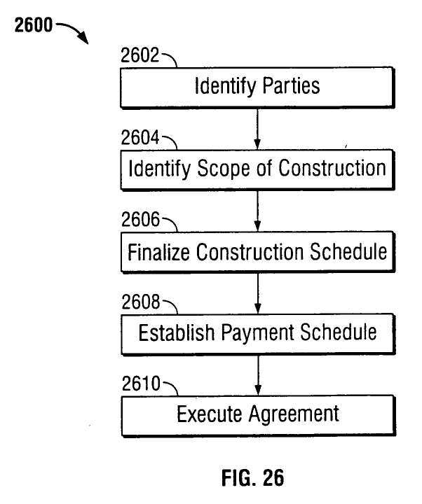

FIG. 26 shows other illustrative details that may be involved in performing step 2306 (shown in FIG. 23). Process 2600 may be used to develop and execute a construction agreement. The agreement may be any suitable construction contract. The agreement may be a Construction Service Agreement. In step 2602 parties to the Interconnection Construction Agreement may be identified. The parties may include a planning entity and one or more of the second entities. In step 2604 a scope of a construction may be identified. The scope may include construction of an infrastructure unit support structure. The scope may include the construction of a power generation equipment building. The scope may include construction of an attachment facility support structure. The scope may include the construction of an attachment facility housing structure. In step 2606, a construction schedule may be finalized. The construction schedule may be based on a schedule established in process 2400, shown in FIG. 24. In step 2608, a payment schedule may be established. The payment schedule may state that funds be transferred from one party to another on an identified date. In step 2610, the agreement may be executed by the parties.

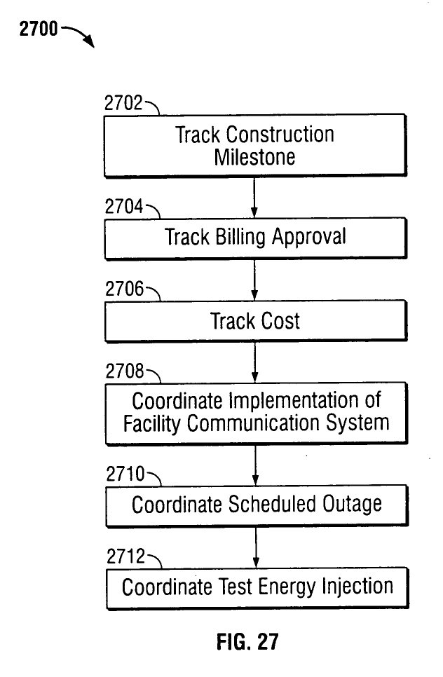

FIG. 27 shows illustrative details that may be involved in performing step 2307. In step 2702; a construction milestone may be tracked. Tracking a construction milestone may involve one or more of inspecting a construction site, receiving a construction status report, comparing a construction site status with an scheduled date and any other step that is suitable for determining if a construction project is in conformance with a schedule. The construction milestone may be a milestone for the construction of a facility to house an infrastructure unit.

In step 2704, a billing approval may be tracked. Tracking a billing approval may involve one or more of review by a project manager and transfer of a bill to an accounts payable department.

In step 2706, a cost may be tracked. Tracking a cost may involve one or more of review by a project manager and performance of accounting analysis.

In step 2708, implementation of a facility communication system may be coordinated. Coordination of a facility communication system may involve installation, at one or more locations, of hardware to support a data communication link.

In step 2710, a scheduled outage may be coordinated. An outage may be scheduled to allow an infrastructure unit to be connected to another, disconnected from another, or tested in a non-energized state.

In step 2712, a test energy injection may be coordinated.

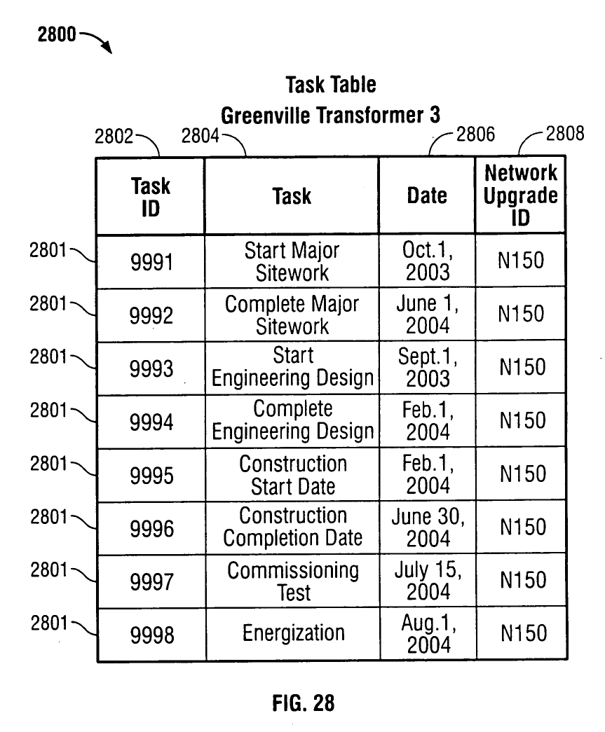

Each of FIGS. 28 and 29 shows an illustrative table that includes an illustrative sample of data that may be present in schedule server 436. It will be understood that the data shown in the tables is for illustrative purposes only. The data in schedule server 436 is not necessarily limited to the amount of data or types of data shown in FIGS. 28-29. Data shown in the tables, or other data that may be present in schedule server 436, may be arranged in any suitable manner. Data shown in the tables, or other data that may be present in schedule server 436, may be displayed in any suitable manner. The data may be stored in any suitable data structure. The data in FIGS. 28-29 may include schedule information associated with infrastructure units. The schedule information may be used by analysis engine 408 (shown in FIG. 4) to identify an operating characteristic as shown at step 516 in FIG. 5.

FIG. 28 shows Task Table 2800. Table 2800 may include schedule information corresponding to one or more tasks that may be involved in the interconnection of exemplary Transformer 3 at exemplary Greenville substation. Each of rows 2801 correspond to a task that may be any task involved in connecting an infrastructure unit to another infrastructure unit, disconnecting an infrastructure unit from another infrastructure unit or modifying an infrastructure unit parameter.

Table 2800 may include “Task ID” column 2802. Column 2802 may show for each task corresponding to a row 2801 a task identifier. A task identifier may uniquely identify a task in schedule server 436. “Task” column 2804 may show a task title such as “Complete Engineering Design”, corresponding to Task ID 9994 in column 2802. “Date” column 2806 may show for each task corresponding to a row 2801 a date on which the task is scheduled to be completed. Table 2800 may include “Network Upgrade ID” column 2808. Column 2808 may for each task corresponding to a row 2801 a network upgrade ID. A Network Upgrade ID may be present in a table such as table 1500 (shown in FIG. 15) to cross reference a task with a model element.

Schedule information may be input into schedule server 436 in any suitable manner, including without limitation via a user access device such as 102 (shown in FIG. 1), a personal computer such as 112 or a remote access device such as 113 (shown in FIG. 2). In some embodiments of the invention, schedule information may be entered into system 400 via interactive display 424. In some embodiments of the invention, schedule information may be included in flow information and received by system 400 in a step such as 508 in process 500 (shown in FIG. 5).

FIG. 29 shows Schedule Server System Upgrades Table 2900. Table 2900 may include schedule information related to one or more network upgrades. Each of rows 2901 may correspond to a network upgrade. “Network Upgrade ID” column 2902 may show for each network upgrade corresponding to a row 2901 a network upgrade identifier. “Description” column 2904 may show for each network upgrade a description of the upgrade. “Status” column 2906 may show for each network upgrade a status of the upgrade. “Cost” 2908 may show for each network upgrade a cost of the upgrade. “Responsible Party” column 2910 may show for each upgrade the name of a party having a responsibility for the upgrade. The responsibility may be a contractual responsibility. The responsibility may be a financial responsibility.

“Cost Allocation” column 2912 may show for each network upgrade a percentage of an upgrade cost allocated to a queue request. For example, a portion of the cost of network upgrade 1260 may be allocated to Queue A and a portion of the cost may be allocated to Queue B (see, for example, FIG. 12). A cost allocation may be set forth in an agreement such as the agreement discussed in connection with step 2306 of process 2300 (shown in FIG. 23). In the example shown in FIG. 29, the cost of upgrade N1 is $300,000, 30% of which is allocated to queue B21 and 70% of which is allocated to queue C02. Further allocation to a party may be effected under an agreement such as that discussed in connection with step 2306 of process 2300 (shown in FIG. 23).

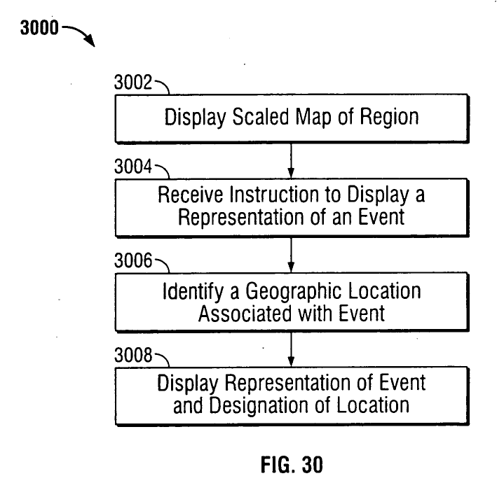

FIG. 30 shows a general flowchart of illustrative steps that may be involved in operating some embodiments of a commodity transport network analysis system in accordance with the principles of the present invention. The steps shown in FIG. 30 are only illustrative and may be performed in any suitable order. In practice, there may be additional steps or some of the steps may be deleted. Some of the steps shown in FIG. 30 may involve providing users with opportunities to interact with the system, performing various processes, or providing various displays. Some of these steps and other steps may be performed by, for example, a client application that is programmed to generate or download screens suitable to provide such opportunities, an Internet browser that downloads suitable pages to provide such opportunities, peer applications, or using any other suitable approach. In an on-line arrangement, access device 102, for example, may be used to run client-based applications, such as a web browser. In non-on-line arrangements, personal computer 112, for example, may run client-based applications.

In on-line arrangements (as shown in FIG. 1), the steps shown in FIG. 30 may be performed by, for example, access device 102, Internet and application server 104, or database server 105, depending on, for example, the processing and storage capabilities of access device 102, the chosen implementation for the markup language documents used, the processing requirements of such operations, or other factors. In non-on-line arrangements (as shown in FIG. 2), such processing may be performed by personal computer 112, remote access device 113, application server 140, database server 105, or distributed among peer applications, depending on the chosen system implementation and the processing requirements of such operations.

For clarity, the following discussion will describe the steps shown in FIG. 30 as being performed by “the system,” which is intended to include any suitable data analysis system, such as, for example, any non-on-line or on-line arrangement suitable for performing the steps. In some embodiments, the system may be system 400. The system may display representations of physical objects, display representations of data objects, exchange information, and perform analyses.

FIG. 30 shows illustrative process 3000 that may be used to display temporally-referenced information on a geographically-referenced display. The temporally-referenced information may include, without limitation, any of the steps (or events associated therewith) described in connection with one or more of processes 2300, 2400, 2500, 2600 and 2700 (shown in FIGS. 23-27, respectively). The temporally-referenced information may include, without limitation any schedule information described in connection with one or more of tables 2800 and 2900 (shown in FIGS. 28-29, respectively).

In step 3002, the system may display a geographically scaled map of a region, for example, using interactive display 424 (shown in FIG. 4). In step 3004, the system may receive a user instruction to display a representation of an event. The user instruction may be received via an input device such as 124 (shown in FIG. 3). In step 3006, the system may identify a geographic location associated with the event. The event may be stored as a tabular data record. The event may be stored as a data object. The data object may include a time value. The data object may include a date value. The event may be stored in a schedule server such as 436 (shown in FIG. 4). The geographic information may be defined in a data object. The object may be stored in a database server such as 430 (shown in FIG. 4). The system may associate the record with the object using a lookup table. In step 3008, the system may display a representation of the event and a designation of the location. The representation may be any suitable representation, such as a graphic, symbolic, textual or photographic representation. The designation may identify a position on the geographically scaled map. The position may be a position at which the event occurred. The position may be a position at which the event is scheduled to occur in the future.

The system may receive a user instruction to display one or more event indicators associated with a model element. The user instruction may be included in a database query. The user instruction may be provided to the system as part of user input 426. The user instruction may be received via a dialog box. The user instruction may be received via any suitable graphical user interface.

FIG. 31 shows illustrative display 3100 that system 400 may provide to a user to enable the user to instruct system 400 to display an event indicator based on a query of a database such as one or more of 402, 430 and 436 (shown in FIG. 4). Display 3100 may include user input feature 3102 that may be configured to receive a user selection of an infrastructure unit type. Display 3100 may include user input feature 3104 that may be configured to receive a user selection of a task type.

Display 3100 may include input feature 3106 that may be configured to receive a user selection of an event. Feature 3106 may include one or more suitable logical limiter such as “before” and “after.” Display 3100 may include input feature 3108 that may be configured to receive a user selection of a date. The date may be used in connection with an event and a logical limiter from feature 3106 to limit the query.

Display 3100 may include event indicator control feature 3110. Feature 3110 may provide the user with an opportunity to select information to be displayed in a representation of an event such as that described in connection with step 3008 of process 3000 (shown in FIG. 30). For example without limitation, feature 3110 may provide the user with an opportunity to select one or more of a project name, a model element ID, a status, a start date, a completion date, a facility date, and a voltage class. Feature 3110 may provide the user with an opportunity to select any suitable information present in one or more of servers 402, 430 and 436 (shown in FIG. 4).

Display 3100 may include user input feature 3116 that may be configured to initiate a database query based on the user selections received by one or more of input features such as 3102, 3104 and 3112 and any other suitable user input feature.

Results of the query may be limited to a geographic region. The results may be limited to a region defined by a map. The results may be limited to a region defined by a displayed map. The map may be labeled for reference. The label may be a “bookmark.” The results may be limited to a region defined by geographic coordinates received from a user. The results may be limited to a political region identified by a user. The results may be limited by any suitable geographic feature that may be displayed on a map such as map 1704 (shown in FIG. 17).

The exemplary query that is illustrated in display 3100 is a query for all transmission line construction completion dates that are scheduled to occur after Apr. 1, 2004. System 400 may execute the query using any suitable database query tool. The query may be based on data present in one or more databases such as those present in network model database server 402, geodatabase server 430 and schedule server 436. It will be appreciated that at least for the purpose of executing a query based on an infrastructure unit type, tables such as those shown in FIGS. 7-11A may each be identified as corresponding to a respective infrastructure type. (For example, the branches shown in rows 701 may be identified as having the infrastructure unit type “transmission line;” the transformers in rows 801 may be identified as having the infrastructure unit type “transformer;” etc.)

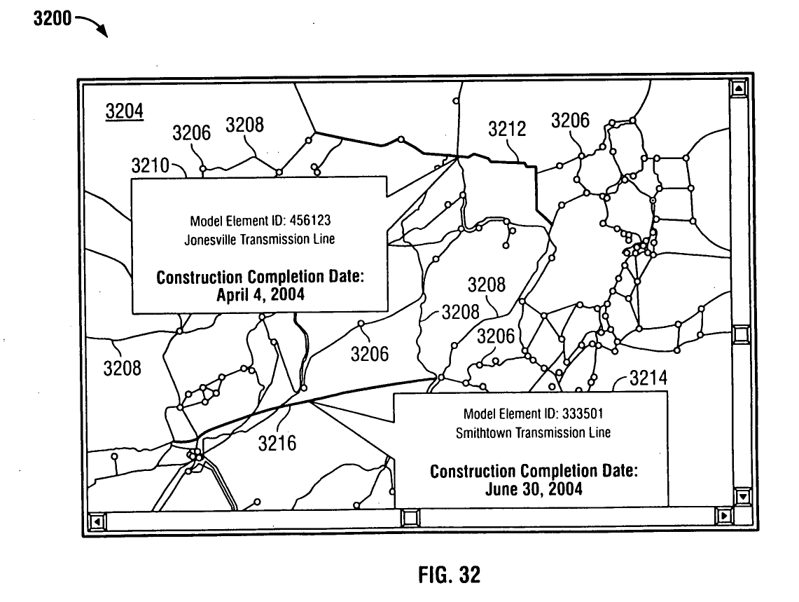

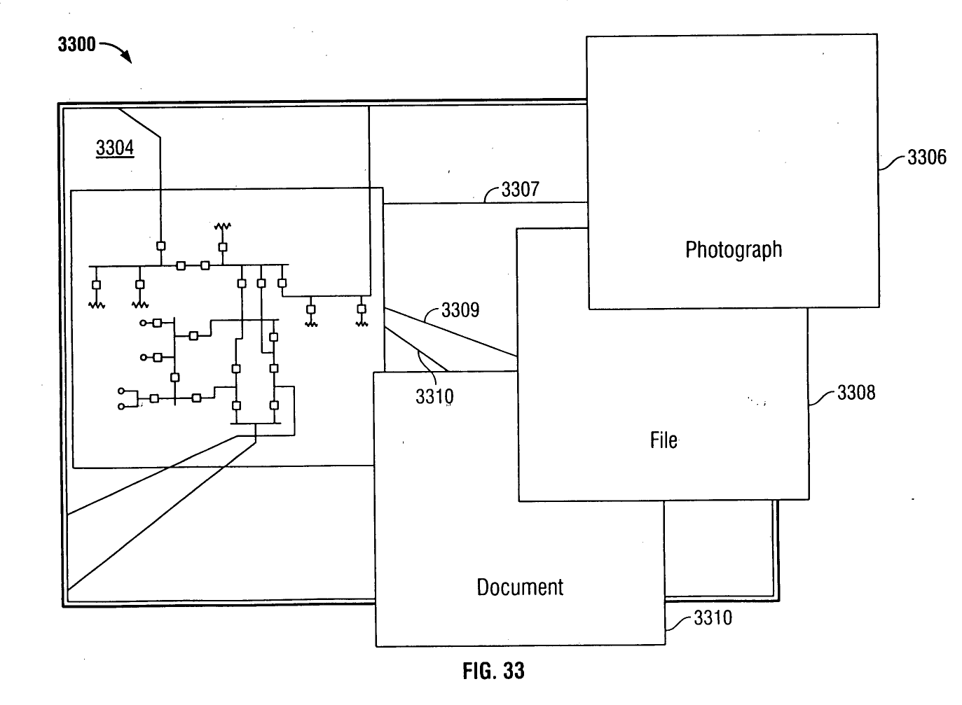

FIGS. 32-33 show illustrative displays that may be provided by a system such as system 400 (shown in FIG. 4). Some or all of the geographic information analysis application features that were described in connection with FIGS. 17-22 may be involved in displays or user input features shown in FIGS. 32-33.

FIG. 32 shows illustrative display 3200 that may be displayed by an interactive display such as 424. Display 3200 may include scaled geographic map 3204. A system such as system 400 may display representations of model elements on map 3204. The representations may include without limitation representations of simulated substations such as substations 3206. Substations 3206 may be shown as being connected by simulated transmission lines 3208. It will be understood that for the sake of clarity, only a small number of substation representations and only a small number of transmission lines have been identified by reference numerals.

FIG. 32 shows illustrative query results from the query defined in FIG. 31. Illustrative event indicator 3210 indicates that a transmission line, viz. Jonesville Transmission Line, has a construction completion date scheduled for Apr. 4, 2004. Indicator 3210 graphically designates Jonesville Transmission Line 3212 as being the location of the construction completion event. Illustrative event indicator 3214 indicates that another transmission line, viz. Smithtown Transmission Line has a construction completion date scheduled for Jun. 30, 2004. Indicator 3214 graphically designates Smithtown Transmission Line as being the location of the construction completion event. (Table 1400 shows that geographic coordinates may be associated with a model element in a database such as a database on geodatabase server 430).

FIG. 33 shows illustrative display 3300, which may include illustrative examples of items that may be displayed in connection with a network. An item may be displayed in connection with any infrastructure unit. The item may be any suitable item, including without limitation, a design document, meeting minutes, an as-built drawing, a project schedule and an invoice.

The item may be displayed in connection with a substation such as that represented by substation representation 3302 on map 3304. The item may include a photograph such as 3306, which may be a digital photograph. The item may include file 3308, which may be a computer aided design (“CAD”) file. The item may include a document such as 3310, which may be text document. In some embodiments of the invention, an item may be identified by an item identifier.

The item may be stored in any suitable storage device. For example, the item may be stored in schedule server 436 (shown in FIG. 4). The item may be cross-referenced to a task ID. In some embodiments, the item may be cross-referenced to the task ID via a look-up table. For example, file 3308 may be a CAD file that includes an engineering design for a generator. The CAD file may be cross-referenced to a task in planning process 2400 (shown in FIG. 24). A line segment such as 3307, 3309 and 3310 may be present in display 3300 to graphically show an association between an item and a representation of an infrastructure unit or a portion of a network.

Thus it is seen that systems and methods for electronically identifying an operating characteristic in a model of a commodity transport network and for representing an event in a display of a project analysis computer system have been provided. One skilled in the art will appreciate that the present invention can be practiced by other than the described embodiments, which are presented for purposes of illustration and not of limitation, and the present invention is limited only by the claims which follow.

1. A method for electronically identifying a simulated operating characteristic in a model of a commodity transport network, said model configured to simulate a flow of said commodity through said network, said method comprising:
displaying a scaled map of a region;
receiving flow information corresponding to a user-selected object displayed on said map; and,
using said flow information, identifying said operating characteristic.

2. The method of claim 1 further comprising, before said identifying, transferring at least a portion of said flow information from a storage device operatively associated with said display to a storage device configured to store data corresponding to an element of said model.

3. The method of claim 2 wherein said identifying comprises communicating at least a portion of said flow information and at least a portion of said data to a commodity transport network analysis computer program.

4. The method of claim 1 wherein at least a portion of said flow information is placed on said map via a user input device.

5. The method of claim 1 wherein said receiving precedes said identifying.

6. The method of claim 1 further comprising, before said receiving flow information, receiving a user instruction to display said object on said map.

7. The method of claim 6 wherein said object represents an element of said model.

8. The method of claim 7 further comprising:
displaying said object; and,
after said displaying said object, transferring at least a portion of said flow information to a storage device configured to store a parameter corresponding to said model element.

9. The method of claim 1 wherein:
said flow information comprises an instruction to remove said object from said map; and,
said receiving precedes said identifying.

10. The method of claim 9 wherein said object represents an element of said model.

11. The method of claim 9 further comprising:
removing said object from said map; and, after said removing said object, transferring at least a portion of said flow information to a storage device configured to store a parameter corresponding to said model element.

12. The method of claim 1 wherein said flow information comprises an instruction to replace a first parameter value corresponding to an element in said model with a second parameter value, said object representing said element.

13. The method of claim 1 wherein said identifying comprises:
computing a value of said operating characteristic; and
displaying on said map a representation of said value.

14. The method of claim 1 wherein said flow information comprises a simulated flow rate.

15. The method of claim 14 wherein said flow rate represents a rate of addition of said commodity at a location on said map.

16. The method of claim 14 wherein said flow rate comprises a rate of consumption of said commodity at a location on said map.

17. The method of claim 16 wherein said rate of consumption corresponds to a load.

18. The method of claim 14 wherein said flow rate represents a rate of removal of said commodity from said network.

19. The method of claim 18 wherein said rate of removal corresponds to a transfer of said commodity from said network.

20. The method of claim 18 wherein said rate of removal corresponds to a transfer of said commodity to a second network.

21. The method of claim 1 wherein said flow information comprises a flow source type.

22. The method of claim 21 wherein said flow source type is an electric power generator.

23. The method of claim 21 wherein said flow source type is a merchant transmission source.

24. The method of claim 1 wherein said flow information comprises simulated outage information.

25. The method of claim 24 wherein said outage information corresponds to a transmission outage.

26. The method of claim 24 wherein said outage information corresponds to an equipment outage.

27. The method of claim 24 wherein said outage information corresponds to a generation plant outage.

28. The method of claim 24 wherein said outage information comprises an out-of-service date.

29. The method of claim 1 wherein:
said flow information comprises an instruction to display on said map, contiguous said user-selected object, a second object;
said user-selected object corresponds to a first model element; and
said second object corresponds to a second model element.

30. The method of claim 29 further comprising displaying on said map said user-selected object and said second object, said second object contiguous said user-selected object.

31. The method of claim 30 further comprising, after said displaying on said map, transferring at least a portion of said flow information to a storage device configured to store a parameter corresponding to a model element.

32. The method of claim 1 wherein said flow information comprises a model element type.

33. The method of claim 32 wherein said model element type is a generator.

34. The method of claim 32 wherein said model element type is a transmission line.

35. The method of claim 32 wherein said model element type is a transformer.

36. The method of claim 32 wherein said model element type is a circuit breaker.

37. The method of claim 32 wherein said model element type is a bus.

38. The method of claim 32 wherein said model element type is a switch.

39. The method of claim 32 wherein said model element type is a load.

40. The method of claim 32 wherein said model element type is a capacitor.

41. The method of claim 32 wherein said model element type is a phase angle regulator.

42. The method of claim 32 wherein said model element type is a wave trap.

43. The method of claim 32 wherein said model element type is switch gear.

44. The method of claim 1 further comprising displaying on said map a monetary value corresponding to an infrastructure unit.

45. The method of claim 44 wherein said monetary value comprises a construction cost value.

46. The method of claim 1 further comprising displaying on said map at least a portion of a document corresponding to an infrastructure unit of said network.

47. The method of claim 46 wherein said document comprises at least a portion of a photograph.

48. The method of claim 46 wherein said document comprises at least a portion of a contract.

49. The method of claim 46 wherein said document comprises at least a portion of an engineering diagram.

50. The method of claim 46 wherein said document comprises project schedule information.

51. The method of claim 1 further comprising associating with a queue a request to connect an infrastructure unit to said network.

52. The method of claim 1 further comprising associating with a queue an element of said model.

53. The method of claim 1 further comprising:
receiving queue identification information identifying a queue; and
displaying on said map a representation of an element corresponding to an infrastructure unit only if said unit is in said queue.

54. The method of claim 1 further comprising:
identifying a first time at which to simulate said flow;
identifying a second time corresponding to an element of said model; and,
if said second time is no earlier than said first time, displaying said model element.

55. The method of claim 54 wherein said second time comprises an in-service date.

56. The method of claim 54 wherein said second time comprises a completion date of a project.

57. The method of claim 54 wherein said second time comprises a contractual date.

58. The method of claim 54 wherein said second time comprises is a certification date.

59. The method of claim 54 wherein said second time comprises a study date.

60. The method of claim 54 further comprising storing said second time in a data storage device.

61. The method of claim 54 further comprising retrieving said second time from a data storage device.

62. The method of claim 1 wherein said identifying comprises calculating a value of said operating characteristic.

63. The method of claim 1 wherein said identifying comprises:
identifying a first time at which to simulate said flow;
identifying a second time corresponding to an element of said model; and,
if said second time is no earlier than said first time, calculating a value of said operating characteristic.

64. The method of claim 63 wherein said second time comprises an in-service date.

65. The method of claim 63 wherein said second time comprises a completion date.

66. The method of claim 63 wherein said completion date is a date of completion of a construction.

67. The method of claim 63 wherein said completion date is a date of completion of an infrastructure unit.

68. The method of claim 63 wherein said completion date is a date of completion of a restoration of an infrastructure unit.

69. The method of claim 63 wherein said second time comprises a contractual date.

70. The method of claim 63 wherein said date is a certification date.

71. The method of claim 63 wherein said date is a study date.

72. The method of claim 1 wherein said identifying comprises comparing a calculated value of said operating characteristic to an established value of said characteristic, said established value associated with an infrastructure unit.

73. The method of claim 72 wherein said unit corresponds to an element of said model.

74. The method of claim 72 wherein said calculated value comprises a voltage value.

75. The method of claim 72 wherein said calculated value comprises a phase angle value.

76. The method of claim 72 wherein said calculated value comprises a current value.

77. The method of claim 76 wherein said current value is at least partially identified as a number of amperes.

78. The method of claim 72 wherein said calculated value comprises a temperature value.

79. The method of claim 72 wherein said calculated value comprises a power value.

80. The method of claim 79 wherein said power value is at least partially identified as a number of watts.

81. The method of claim 79 wherein said power value is identified as a number of VARS.

82. The method of claim 72 wherein said established value corresponds to a design characteristic.

83. The method of claim 72 wherein said established value comprises a voltage value.

84. The method of claim 72 wherein said established value comprises a phase angle value.

85. The method of claim 72 wherein said established value comprises a current value.

86. The method of claim 85 wherein said current value is at least partially identified as a number of amperes.

87. The method of claim 72 wherein said established value comprises a temperature value.

88. The method of claim 72 wherein said established value comprises a power value.

89. The method of claim 88 wherein said power value is at least partially identified as a number of watts.

90. The method of claim 89 wherein said power value is at least partially identified as a number of VARS.

91. The method of claim 72 wherein said comparing comprises identifying a difference between said calculated value and said established value.

92. The method of claim 91 further comprising displaying on said map a representation of said difference.

93. The method of claim 92 wherein said representation of said difference is associated graphically with a representation of an element of said model.

94. The method of claim 93 wherein said representation of said difference comprises an area of said map surrounding said representation of said element.

95. The method of claim 1 wherein said commodity comprises electric power.

96. The method of claim 1 wherein said network comprises an electric power transmission grid.

97. The method of claim 1 wherein said flow comprises electric current.

98. The method of claim 97 wherein said current comprises an alternating current.

99. The method of claim 97 wherein said current comprises a direct current.

100. A method for representing an event in a display of a project planning analysis computer system, said method comprising:
representing on said display a scaled map of a region; and
displaying on said display an indication of said event;
wherein said indication designates a position in said display, said position corresponding to a location of said event.

101. The method of claim 100 wherein said event comprises an initiation of a construction.

102. The method of claim 100 wherein said event comprises a completion of a construction.

103. The method of claim 100 wherein said event comprises an initiation of a study.

104. The method of claim 100 wherein said study comprises a planning power analysis study.

105. The method of claim 100 wherein said event comprises a completion of a study.

106. The method of claim 100 wherein said event comprises an execution of an agreement.

107. The method of claim 100 wherein said event comprises an initiation of a test.

108. The method of claim 100 wherein said event comprises a completion of a test.

109. The method of claim 100 wherein said event comprises an initiation of an inspection.

110. The method of claim 100 wherein said event comprises a completion of an inspection.

111. The method of claim 100 wherein said event comprises an authorization of an expenditure.

112. The method of claim 111 wherein said expenditure is identified in an agreement.

113. The method of claim 111 wherein said agreement comprises an interconnection service agreement.

114. The method of claim 111 wherein said expenditure is identified in a budget.

115. The method of claim 111 wherein said expenditure corresponds to a purchase of electrical equipment.

116. The method of claim 115 wherein said expenditure corresponds to a service of electrical equipment.

117. The method of claim 100 wherein said event comprises a receipt of funds.

118. The method of claim 100 wherein said funds correspond to a purchase of electrical equipment.

119. The method of claim 100 wherein said funds correspond to a service of electrical equipment.

120. The method of claim 100 further comprising comparing a first amount to a second amount; wherein:
said first amount corresponds to a transfer of funds, said event comprising said transfer; and said second amount is identified in a budget.

121. The method of claim 100 wherein said event is part of an infrastructure unit modification, said infrastructure unit configured for interconnection with a commodity transport network.

122. The method of claim 100 wherein said commodity comprises electric power.

123. The method of claim 100 wherein said displaying comprises identifying a time-referenced data record with a geographically-referenced data object corresponding to said position.

124. The method of claim 123 wherein:
said record corresponds to said event; and
said associating comprises identifying said event in a lookup table, said table comprising:
an identifier of said record; and
an identifier of said object.

125. The method of claim 100 further comprising displaying an item on said display, said item corresponding to said event.

126. The method of claim 125 wherein said item comprises at least a portion of a photograph.

127. The method of claim 125 wherein said item comprises project schedule information.

128. The method of claim 125 wherein said item comprises a date.

129. The method of claim 128 wherein said date is an in-service date.

130. The method of claim 128 wherein said date is a date of completion of a project.

131. A system for electronically identifying a simulated operating characteristic in a model of a commodity transport network, said model configured to simulate a flow of said commodity through said network, said system comprising:
an electronic display device configured to display a scaled map of a region;
a user input device configured to receive flow information corresponding to a user-selected object location displayed on said map; and,
a processor configured to use said flow information to identify said operating characteristic.

132. The system of claim 131 further comprising a storage device configured to store a parameter of an element of said model; wherein, when said object comprises an attribute corresponding to said parameter:
said flow information includes an instruction to assign a value to said attribute; and
said display device is configured to communicate to said storage device an instruction to assign said value to said parameter.

133. The system of claim 131 wherein said processor is configured to use said value to identify said operating characteristic.

134. The system of claim 131 further comprising a storage device configured to store a parameter of an element of said model; wherein, when said object comprises an attribute corresponding to said parameter:
said flow information includes an instruction to delete a value of said attribute; and
said display device is configured to communicate to said storage device an instruction to delete said value to said parameter.

135. The system of claim 131 wherein said user input device is configured to receive an instruction to display object on said map.

136. The system of claim 131 wherein:
said processor is further configured to compute a value of said operating characteristic; and
said display device is further configured to display on said map a representation of said value.

137. The system of claim 131 wherein said flow information comprises a simulated flow rate.

138. The system of claim 137 wherein said flow rate represents a rate of addition of said commodity at a location on said map.

139. The system of claim 137 wherein said flow rate comprises a rate of consumption of said commodity at a location on said map.

140. The system of claim 139 wherein said rate of consumption corresponds to a load.

141. The system of claim 137 wherein said flow rate represents a rate of removal of said commodity from said network.

142. The system of claim 141 wherein said rate of removal corresponds to a transfer of said commodity from said network.

143. The system of claim 141 wherein said rate of removal corresponds to a transfer of said commodity to a second network.

144. The system of claim 131 wherein said flow information comprises a flow source type.

145. The system of claim 144 wherein said flow source type is an electric power generator.

146. The system of claim 144 wherein said flow source type is a merchant transmission source.

147. The system of claim 148 wherein said flow information comprises simulated outage information.

148. The system of claim 147 wherein said outage information corresponds to a transmission outage.

149. The system of claim 147 wherein said outage information corresponds to an equipment outage.

150. The system of claim 147 wherein said outage information corresponds to a generation plant outage.

151. The system of claim 147 wherein said outage information comprises an out-of-service date.

152. The system of claim 131 wherein said display device is further configured to display on said map a first representation of a first model element.

153. The system of claim 152 wherein:
said flow information comprises an instruction to display on said map, contiguous said user-selected object, a second object; and
said display is configured to display said second object contiguous said user-selected object.

154. The system of claim 131 wherein said flow information comprises a model element type.

155. The system of claim 154 wherein said model element type is a generator.

156. The system of claim 154 wherein said model element type is a transmission line.

157. The system of claim 154 wherein said model element type is a transformer.

158. The system of claim 154 wherein said model element type is a circuit breaker.

159. The system of claim 154 wherein said model element type is a bus.

160. The system of claim 154 wherein said model element type is a switch.

161. The system of claim 154 wherein said model element type is a load.

162. The system of claim 154 wherein said model element type is a capacitor.

163. The system of claim 154 wherein said model element type is a phase angle regulator.

164. The system of claim 154 wherein said model element type is a wave trap.

165. The system of claim 154 wherein said model element type is switch gear.

166. The system of claim 131 wherein said display device is further configured to display on said map a monetary value corresponding to an infrastructure unit.

167. The system of claim 166 wherein said monetary value comprises a construction cost value.

168. The system of claim 131 wherein said display device is further configured to display on said map at least a portion of a document corresponding to an infrastructure unit of said network.

169. The system of claim 168 wherein said document comprises at least a portion of a photograph.

170. The system of claim 168 wherein said document comprises at least a portion of a contract.

171. The system of claim 168 wherein said document comprises at least a portion of an engineering diagram.

172. The system of claim 168 wherein said document comprises project schedule information.

173. The system of claim 131 wherein said processor is further configured to select for processing an element of said model if said element is associated with a user-selected queue.

174. The system of claim 131 wherein said display is further configured to display on said map a representation of a model element only if said model element is associated with said queue.

175. The system of claim 131 wherein:
said user input device is further configured to receive a first time at which to simulate said flow; and
said processor is further configured to:
identify a second time corresponding to an element of said model; and,
if said second time is no earlier than said first time, display an object corresponding to said model element.

176. The system of claim 175 wherein said second time comprises an in-service date.

177. The system of claim 175 wherein said second time comprises a completion date of a project.

178. The system of claim 175 wherein said second time comprises a contractual date.

179. The system of claim 175 wherein said second time comprises is a certification date.

180. The system of claim 175 wherein said second time comprises a study date.

181. The system of claim 175 further comprising a data storage device configured to store said second time.

182. The system of claim 175 wherein said processor is further configured to retrieve said second time from a data storage device.

183. The system of claim 131 wherein said processor is further configured to calculate a value of said operating characteristic.

184. The system of claim 131 wherein said processor is configured to:
identify a first time at which to simulate said flow;
identify a second time corresponding to an element of said model; and,
if said second time is no earlier than said first time, calculate a value of said operating characteristic.

185. The system of claim 184 wherein said second time comprises an in-service date.

186. The system of claim 184 wherein said second time comprises a completion date.

187. The system of claim 184 wherein said completion date is a date of completion of a construction.

188. The system of claim 184 wherein said completion date is a date of completion of an infrastructure unit.

189. The system of claim 184 wherein said completion date is a date of completion of a restoration of an infrastructure unit.

190. The system of claim 184 wherein said second time comprises a contractual date.

191. The system of claim 184 wherein said date is a certification date.

192. The system of claim 184 wherein said date is a study date.

193. The system of claim 131 wherein said processor is configured to compare a calculated value of said operating characteristic to an established value of said characteristic, said established value associated with an infrastructure unit.

194. The system of claim 193 wherein said unit corresponds to an element of said model.

195. The system of claim 193 wherein said calculated value comprises a voltage value.

196. The system of claim 193 wherein said calculated value comprises a phase angle value.

197. The system of claim 193 wherein said calculated value comprises a current value.

198. The system of claim 197 wherein said current value is at least partially identified as a number of amperes.

199. The system of claim 193 wherein said calculated value comprises a temperature value.

200. The system of claim 193 wherein said calculated value comprises a power value.

201. The system of claim 200 wherein said power value is at least partially identified as a number of watts.

202. The system of claim 200 wherein said power value is identified as a number of VARS.

203. The system of claim 193 wherein said established value corresponds to a design characteristic.

204. The system of claim 193 wherein said established value comprises a voltage value.

205. The system of claim 193 wherein said established value comprises a phase angle value.

206. The system of claim 193 wherein said established value comprises a current value.

207. The system of claim 206 wherein said current value is at least partially identified as a number of amperes.

208. The system of claim 193 wherein said established value comprises a temperature value.

209. The system of claim 193 wherein said established value comprises a power value.

210. The system of claim 209 wherein said power value is at least partially identified as a number of watts.

211. The system of claim 210 wherein said power value is at least partially identified as a number of VARS.

212. The system of claim 193 wherein said processor is further configured to identify a difference between said calculated value and said established value.

213. The system of claim 212 wherein said display device is further configured to display on said map a representation of said difference.

214. The system of claim 213 wherein said display device is further configured to graphically associate said representation of said difference with a representation of an element of said model.

215. The system of claim 214 wherein said representation of said difference comprises an area of said map surrounding said representation of said element.

216. The system of claim 131 wherein said commodity comprises electric power.

217. The system of claim 131 wherein said network comprises an electric power transmission grid.

218. The system of claim 131 wherein said flow comprises electric current.

219. The system of claim 218 wherein said current comprises an alternating current.

220. The system of claim 218 wherein said current comprises a direct current.

221. A system for representing an event in a display of a project planning analysis computer system, said system comprising:
an electronic display device configured to display a scaled map of a region;
at least one data storage device; and
a processor configured to retrieve from said at least one storage device a time-referenced data record and a geographically-referenced data object, said data object identified with said data record; wherein:
said display device is configured to display an indication of said event; and
said indication designates a position in said display corresponding to a location of said event.

222. The system of claim 221 wherein said event comprises an initiation of a construction.

223. The system of claim 221 wherein said event comprises a completion of a construction.

224. The system of claim 221 wherein said event comprises an initiation of a study.

225. The system of claim 221 wherein said study comprises a planning power analysis study.

226. The system of claim 221 wherein said event comprises a completion of a study.

227. The system of claim 221 wherein said event comprises an execution of an agreement.

228. The system of claim 221 wherein said event comprises an initiation of a test.

229. The system of claim 221 wherein said event comprises a completion of a test.

230. The system of claim 221 wherein said event comprises an initiation of an inspection.

231. The system of claim 221 wherein said event comprises a completion of an inspection.

232. The system of claim 221 wherein said event comprises an authorization of an expenditure.

233. The system of claim 232 wherein said expenditure is identified in an agreement.

234. The system of claim 232 wherein said agreement comprises an interconnection service agreement.

235. The system of claim 232 wherein said expenditure is identified in a budget.

236. The system of claim 232 wherein said expenditure corresponds to a purchase of electrical equipment.

237. The system of claim 232 wherein said expenditure corresponds to a service of electrical equipment.

238. The system of claim 221 wherein said event comprises a receipt of funds.

239. The system of claim 221 wherein said funds correspond to a purchase of electrical equipment.

240. The system of claim 221 wherein said funds correspond to a service of electrical equipment.

241. The system of claim 221 wherein said processor is further configured to compare a first amount to a second amount;
wherein:
said first amount corresponds to a transfer of funds, said event comprising said transfer; and
said second amount is identified in a budget.

242. The system of claim 221 wherein said event is part of an infrastructure unit modification, said infrastructure unit configured for interconnection with a commodity transport network.

243. The system of claim 221 wherein said commodity comprises electric power.

244. The system of claim 221 wherein said processor is configured to identify said event in a look-up table, said table comprising:
an identifier of said record; and
an identifier of said object.

245. The system of claim 221 wherein said display device is further configured to display an item corresponding to said event.

246. The system of claim 245 wherein said item comprises at least a portion of a photograph.

247. The system of claim 245 wherein said item comprises project schedule information.

248. The system of claim 245 wherein said item comprises a date.

249. The system of claim 245 wherein said date is an in-service date.

250. The system of claim 245 wherein said date is a date of completion of a project.
